(19) United States
(12) Patent Application Publication
(10) Pub. No.: US 2019/0016909 A1
(43) Pub. Date: Jan. 17, 2019

(54) TEMPLATE SYNTHESIS OF POLYMERIC NANOMATERIALS BY INK-JET PRINTING

(71) Applicant: University of Notre Dame du Lac, South Bend, IN (US)

(72) Inventors: William A. PHILLIP, Granger, IN (US); Siyi Qu, South Bend, IN (US); Sherwood BENAVIDES, Notre Dame, IN (US); Peng GAO, Mishawaka, IN (US); Feng GAO, Notre Dame, IN (US)

(73) Assignee: University of Notre Dame du Lac, South Bend, IN (US)

(21) Appl. No.: 16/069,358

(22) PCT Filed: Jan. 11, 2017
(86) PCT No.: PCT/US17/13052

§ 371 Date: Jul. 11, 2018

Related U.S. Application Data
(60) Provisional application No. 62/277,444, filed on Jan. 11, 2016.

(51) Int. Cl. C09D 11/30; C09D 11/033; C09D 11/106; C09D 11/107; C09D 11/102

(52) U.S. Cl. CPC C09D 11/30; C09D 11/033; B82Y 40/00; C09D 11/107; C09D 11/102; C09D 11/106

(57) ABSTRACT

A method for fabricating nanostructured polymeric materials based on a combination of inkjet printing and template synthesis. Layer-by-layer assembled nanotubes can be synthesized in a polycarbonate track-etched (PCTE) membrane by printing poly(allylamine hydrochloride) (PAH) and poly(styrenesulfonate) (PSS) sequentially. By changing the printing conditions, polymeric nanotubes or nanowires can be prepared by printing poly(vinyl alcohol) (PVA) in a PCTE template. Inkjet printing paired with template synthesis can be used to generate patterns comprised of chemically distinct nanomaterials. Thin polymeric films of layer-by-layer assembled PAH and PSS can be printed on a PCTE membrane. Inkjet printing paired with template synthesis can also be used to prepare functional mosaic membranes, such as charge mosaic membranes comprising polyelectrolytes of different charges to pattern positively charged or negatively-charged domains, respectively, on the surface of the template.

### RELATED APPLICATIONS

This application claims priority under 35 U.S.C. § 119(e) to U.S. Provisional Patent Application No. 62/277,444, filed Jan. 11, 2016, which is incorporated herein by reference.

### BACKGROUND OF THE INVENTION

Nanomaterials, such as nanotubes and nanowires, have been explored by the scientific and engineering communities for use in many industrial arenas, including water treatment, energy storage devices, and pharmaceutical applications. The two main strategies for the fabrication of nanomaterials can be classified broadly as top-down and bottom-up methods. Top-down approaches reduce bulk materials to the nanometer scale by using chemical or mechanical techniques, e.g., lithography and milling. Bottom-up methods construct nanomaterials through the deposition of atoms or molecules that are directed into place by self-assembly, directed-assembly, or template synthesis. Template synthesis, which is the focus of this patent, uses a sacrificial template, such as polycarbonate track-etched (PCTE) membranes, to guide the deposition of material onto the surface of the template. In the case of PCTE membranes, polymeric, carbon, metallic, and semiconducting materials have been deposited within the pores of the membrane to form nanotubes or nanowires. Despite the versatility of the template synthesis method, the fabrication of nanomaterials with complex structures or functionality can be time consuming, laborious, and costly. For example, a recent study implemented template synthesis to generate polyelectrolyte nanotubes that were subsequently used for the fabrication of charge mosaic membranes. Rajesh, S.; Yan, Y.; Chang, H.; Gao, H.; Phillip, W. A.; Mixed Mosaic Membranes Prepared by Layer-by-Layer Assembly for Ionic Separations, ACS Nano (2014) 8, pages 12338-12345. The layer-by-layer (LbL) process used in the study to deposit the polyelectrolytes within the template took roughly five days to complete. Furthermore, the fabrication of patterned nanostructures generally requires lithography, which is laborious.

Inkjet printing is a technology that offers a rapid and reliable method for depositing precise amounts of functional materials to specific locations on a substrate. Since its commercialization in the 1970s, inkjet printing devices for both small-scale home usage and large-scale industrial applications have been developed. As the technology has become more widespread, the use of these devices has been extended beyond printing graphical images, and the trend towards printing functional materials is increasing. Examples of useful devices that have been printed from functional materials include polymeric light-emitting diodes displays and electronic circuits, microbatteries, thin film transistors, tissues, and drug release systems. These devices can be printed as two-dimensional and three-dimensional structures.

The dimension of materials printed using currently available printing techniques has a lower limit near 20 μm because the accurate deposition of ink by an inkjet printer relies on droplet ejection from a signal-responsive printer head. The resolution of the printer depends on many aspects, including nozzle size, physical and chemical properties of the substrate, and properties of the ink. Ultimately, the resolution of current inkjet technology is in the micrometer range due to capillary forces. A fast and reliable method to move beyond this limitation and print materials with nanometer scale via inkjet printing would enable numerous future applications at the nanoscale.

There have also been a number of studies to fabricate multifunctional mosaic membranes. Most conventional membrane systems are based on size-selective materials that permeate smaller molecules and retain larger ones. However, membranes that can permeate larger molecules more rapidly than smaller ones can find widespread utilization in multiple arenas of technology. Charge mosaic membranes are one example of such a system. Due to their unique nanostructure, which consists of discrete oppositely-charged domains, charge mosaics are capable of permeating large dissolved salts more rapidly than smaller water molecules.

The commercial success of membrane separations has largely been based on size-selective materials that allow smaller molecules to permeate while retaining larger molecules. In several arenas, however, significant advantages exist for chemically-selective membranes that are capable of permeating larger molecules more quickly than smaller molecules. Charge mosaic membranes, which possess discrete oppositely-charged domains, are an example of a membrane that can permeate large dissolved salts more rapidly than similarly-sized neutral solutes and smaller water molecules. However, materials processing challenges have hindered their advancement.

Charge mosaic membranes possess arrays of both positively and negatively charged domains. The juxtaposition of the counter-charged domains allows both cations and anions to permeate through the charge-functionalized membrane without violating the macroscopic constraint of electroneutrality, which greatly enhances the overall permeability of electrolytes. The concept of a charge mosaic membrane was first proposed by Sollner in 1932. Since then, multiple attempts have been made to develop charge mosaic membranes from several polymeric materials platforms, including self-assembled block polymers, ion exchange resins, electrospun polymers, polymer blends, and layer-by-layer (LbL) deposition.

Past efforts have identified some design criteria for the generation of high-performance charge mosaic membranes. For example, the oppositely-charged domains are advantageously densely packed on the membrane surface and advantageously traverse the membrane thickness. Additionally, it is advantageous that the surface charge densities of the positively-charged and negatively-charged domains are as high as possible. The net surface charge averaged over the whole membrane surface, however, is advantageously neutral. The straightforward fabrication of highly-effective charge mosaics from prior materials systems has proven difficult due to the need to orient the ionic domains perpendicular to the surface, and the morphological changes induced during the harsh chemical treatments required to introduce charged moieties into some materials. These materials processing challenges have made it difficult to satisfy the design criteria. Due to this difficulty in producing charge mosaics, the development of a viable mosaic membrane platform has lagged.

Accordingly, there is a need for improved, reliable, high-throughput, and economic fabrication methods for the preparation of nanomaterials with complex structures.

### SUMMARY

In this patent, we describe a novel method for fabricating nanostructured polymeric materials based on a combination of inkjet printing and template synthesis. The method is versatile, reliable, and rapid. We demonstrate the method by preparing polymeric materials, such as nanotubes, nanowires, multilayer thin films, and multifunctional mosaic membranes. While we describe methods of fabricating nanomaterials throughout the patent, it is understood that the methods can also be utilized to produce films and functional mosaic membranes that are larger than nano-sized materials. The printed nanomaterials can retain the same functionality as their conventional dip-coated counterparts, which require significantly longer fabrication times, make less efficient use of precursor materials, and cannot produce patterned surfaces. Incorporating template synthesis with inkjet printing can shorten and simplify the fabrication, patterning, and modification of nanomaterials with complex structures and multi-functionality, and produce novel complex structures.

We describe the straightforward fabrication of charge mosaics using a combination of inkjet printing and template synthesis. Our results suggest that this combination addresses the processing challenges that have stymied the advancement of chemically-selective mosaic membranes and that the simple operation, facile control over surface structure, and diverse range of materials that can be implemented in this method can enable the ultimate widespread utilization of mosaic membranes for myriad applications, e.g., cell patterned sensors and textured surfaces for anti-fouling applications.

In one aspect of the invention, a method is provided for preparing a polymeric nanomaterial comprising ink-jet printing a polymeric ink on a porous or non-porous sacrificial template and synthesizing the polymeric nanomaterial on the template. The polymeric nanomaterial can be a nanotube or a nanowire and fabricated by:

(i) ink-jet printing sequentially at least two layers of the polymeric ink on the porous sacrificial template while pulling a vacuum on the downstream side of the template; and

(ii) dissolving the sacrificial template in an organic solvent to form the polymeric nanotube or nanowire;

In an embodiment, the polymeric ink comprises a polyelectrolyte, a neutral polymer, or a combination thereof.

In an embodiment, at least two different types of polymeric ink are ink-jet printed alternatively on the template. The two different types of polymeric ink can have opposite charges to form alternative positive and negative charged layers.

In another aspect of the invention, a method is provided for preparing a polymeric film comprising ink-jet printing a polymeric ink on a porous or non-porous sacrificial template and synthesizing the polymeric film on the template. The polymeric film can be a multi-layered film and fabricated by ink-jet printing sequentially at least two layers of the polymeric ink on the porous or non-porous template in the absence of an applied vacuum on the template to form the polymeric film. In an embodiment, the film is a nanomaterial.

In still another aspect of the invention, a method is provided for preparing a functional mosaic membrane comprising ink-jet printing a polymeric ink on a porous or non-porous sacrificial template and synthesizing the functional mosaic membrane on the template.

In an embodiment, the functional mosaic membrane comprises a charge mosaic membrane comprising alternative layers of at least two different polymeric inks comprising polyelectrolytes of different charges to pattern positively-charged or negatively-charged domains, respectively, on the surface of the template.

The novel method of combining template synthesis with inkjet printing can facilitate a facile and fast fabrication of old and new multi-functional, nano-sized polymeric complex structures.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 shows a schematic diagram of nanomaterials [(a) nanotubes; (b) nanowires; and (c) thin films] generated by coupling inkjet printing with template synthesis.

FIG. 2 shows SEM micrographs of printed PAH/PSS nanostructures generated by coupling inkjet printing with template synthesis.

FIG. 3 shows SEM micrographs of printed (a) PVA nanowires and (b) PVA nanotubes generated by coupling inkjet printing with template synthesis.

FIG. 4 shows images of printed patterns of (a) dots and (b) an ND logo comprising nanotubes (or nanowires) generated by coupling inkjet printing with template synthesis.

FIG. 5 shows (a) an image, (b) a SEM micrograph, and (c) a SEM-EDX image of a printed pattern of stripes comprising PVA nanowires generated by coupling inkjet printing with template synthesis.

FIG. 6 shows graphs of (a) streaming current/pressure and (b) streaming current and water permeability versus the number of bilayers for layer-by-layer (LbL) printed PAH/PSS nanotubes generated by coupling inkjet printing with template synthesis.

FIG. 7 shows a graph of applied pressure and streaming current versus time for layer-by-layer (LbL) printed PAH/PSS nanotubes generated by coupling inkjet printing with template synthesis.

FIG. 8 shows a graph of the mass of permeate versus time displaying the water permeability and ion rejection measurements for PAH/PSS thin films generated by coupling inkjet printing with template synthesis.

FIG. 9 shows a graph displaying the water permeability and salt rejection of a layer-by-layer (LbL) thin film prepared with 0 M NaCl and 0.5 M NaCl supporting electrolyte solutions.

FIG. 10 shows the water permeability and rejection of magnesium sulfate with different numbers of PAH/PSS bilayers printed on a PCTE membrane generated by coupling inkjet printing with template synthesis.

FIG. 11 shows a SEM micrograph of a PAH/PSS thin film covered with crystalized salt printed on a PCTE membrane template.

FIG. 12 shows fluorescent and SEM micrographs of PVA nanowires printed as patterned stripes generated by coupling inkjet printing with template synthesis.

FIG. 13 shows a schematic diagram of a charge mosaic membrane generated by coupling inkjet printing with template synthesis.

FIG. 14 shows a Fourier transform infrared spectroscopy (FTIR) spectra and fluorescent images of printed membranes with or without chemical cross-linking.

FIG. 15 displays the stability of salt rejection measurements for charge mosaic membranes cross-linked under different conditions.

FIG. 16 shows the viscosity values of polymer composite inks containing different concentrations of poly electrolytes.

FIG. 17 shows streaming current of charge-functionalized membranes prepared using a combination of inkjet printing and template synthesis.

FIG. 18 shows SEM images of the PVA/PDADMAC and PVA/PSS nanowires after dissolving the PCTE template membrane.

FIG. 19 shows fluorescent images, streaming current, and salt rejection for charge mosaic membranes printed with different areal fractions of positive and negative charge.

FIG. 20 shows SEM micrographs of a charge mosaic membrane.

### DETAILED DESCRIPTION

The fabrication of functional nanomaterials with complex structures has been serving great scientific and practical interests, but current fabrication and patterning methods are generally costly and laborious. Here, we introduce a versatile, reliable, and rapid method for fabricating nanostructured polymeric materials. In one aspect, the novel method is based on a combination of inkjet printing (including e-jet printing) and template synthesis, and its utility and advantages in the fabrication of polymeric nanomaterials is demonstrated through three examples: the generation of polymeric nanotubes, nanowires, and thin films. Layer-by-layer assembled nanotubes can be synthesized in a polycarbonate track-etched (PCTE) membrane by printing poly(allylamine hydrochloride) (PAH) and poly(styrenesulfonate) (PSS) sequentially. This sequential deposition of polyelectrolyte ink enables control over the surface charge within the nanotubes. By simply changing the printing conditions, polymeric nanotubes or nanowires can be prepared by printing poly(vinyl alcohol) (PVA) in a PCTE template. In this case, the high throughput nature of the method enables functional nanomaterials to be generated in under 3 minutes. Furthermore, we demonstrate that inkjet printing paired with template synthesis can be used to generate patterns comprised of chemically distinct nanomaterials. Thin polymeric films of layer-by-layer assembled PAH and PSS are printed on a PCTE membrane. Track-etched membranes covered with the deposited thin films reject ions and can potentially be utilized as nanofiltration membranes. By demonstrating the fabrication of these different classes of nanostructured materials, the advantages of pairing template synthesis with inkjet printing, which include fast and reliable deposition, judicious use of the deposited materials, and the ability to design chemically-patterned surfaces, are highlighted.

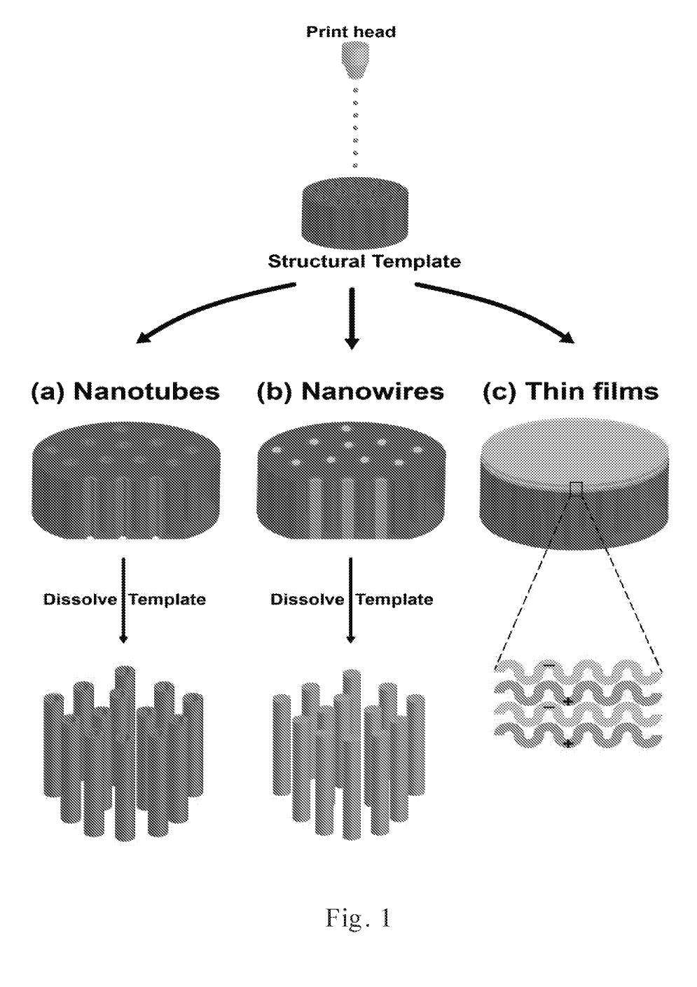

We describe herein a novel method of combining ink-jet printing and template synthesis to fabricate polymeric nanomaterials. In order to highlight the versatility of incorporating template synthesis with inkjet printing, the fabrication of polymeric nanotubes, nanowires, and thin films are examined (FIG. 1). Only simple modifications to the printing solution and/or process were needed to generate different nanostructures when combining inkjet printing and template synthesis.

FIG. 1 shows a schematic of the nanomaterials generated by coupling inkjet printing with template synthesis. In (a) of FIG. 1, polymeric nanotubes are prepared by printing PAH and PSS alternately on a PCTE membrane template while pulling vacuum on the downstream side of the template. In (b) of FIG. 1, polymeric nanowires are generated by simply printing PVA on a membrane template while pulling a vacuum. In (c) of FIG. 1, layer-by-layer (LbL) thin films are fabricated on top of a PCTE membrane by printing alternating layers of PAH and PSS in the absence of an applied vacuum.

Solutions with a viscosity of less than about 25 mPa s can be used as functional “inks” when printing from a standard inkjet printer. This description utilized polymers dissolved in deionized (DI) water, namely, the polyelectrolytes PAH and PSS, and the neutral polymer, PVA. PAH and PSS were used for printing nanotubes and thin films because layer-by-layer (LbL) assembly of polyelectrolytes is a straightforward method for preparing multilayer polymeric films. PVA was selected as a model polymer because it has been previously reported that it can form nanowires in anodized alumina oxide membranes through dip coating processes.

In embodiments, the concentration(s) of the polyelectrolyte(s) are tailored to provide a suitable viscosity and vapor pressure for optimum ink-jet printing. They usually are between about 0.01 mM and about 1.0M. In embodiments, the concentration of the neutral polymer is usually between about 0.1 wt % and about 2 wt %. In embodiments, the polymeric ink comprises water. In some embodiments, the polymers were dissolved at concentrations that produce aqueous solutions with viscosities around 1 mPa. This corresponds to about 20 mM (based on repeat units) solutions of PAH and PSS and a 0.3 wt % solution of PVA. Although, only water-soluble materials are exemplified herein, it is reasonable to expect that other materials and solvents (i.e., organic solvents, such as alcohols) can be implemented as long as the resulting solutions have a viscosity and vapor pressure within the suitable range for printing and the printing device being implemented is compatible with the solvent of choice.

In embodiments, the PCTE template membranes have pore sizes between about 5 nm and about 200 nm, about 25 nm and about 200 nm, and about 50 nm and about 200 nm. The pores in these membranes have a well-controlled and well-defined size, which make them ideal for producing nanotubes and nanowires. Dip coating methodologies rely on the diffusive transport of the polymeric building blocks into the pores of the template. This results in manually-intensive protocols that require long periods of time to implement. Printing processes may have an advantage in the fabrication of these nanomaterials due to their high throughput nature and reduced labor. In particular, when vacuum-assisted template synthesis is coupled with printing, the ballistic transport of the constituent polymers into the pores of the PCTE template reduces the times necessary to produce nanostructures greatly. Alternatively, when an applied vacuum is not used to assist the process, a thin film can be deposited on top of the PCTE.

The polyelectrolyte can be a polyanion or a polybase. Polyanions comprise naturally occurring polyanions and synthetic polyanions. Examples of naturally occurring polyanions include alginate, carboxymethylamylose, carboxymethylcellulose, carboxymethyldextran, carageenan, cellulose sulfate, chondroitin sulfate, chitosan sulfate, dextran sulfate, gum arabic, guar gum, gellan gum, heparin, hyaluronic acid, pectin, xanthan and proteins at an appropriate pH. Examples of synthetic polyanions are polyacrylates (salts of polyacrylic acid), anions of polyamino acids and their copolymers, polymaleate, polymethacrylate, polystyrene sulfate, poly(styrene sulfonate) (PSS), polyvinyl phosphate, polyvinyl phosphonate, polyvinyl sulfate, polyacrylamidomethylpropane sulfonate, polylactate, poly(butadiene/maleate), poly(ethylene/maleate), poly(ethacrylate/acrylate), and poly(glyceryl methacrylate).

Suitable polybases comprise naturally occurring polycations and synthetic polycations. Examples of suitable naturally occurring polycations include chitosan, modified dextrans, for example, diethylaminoethyl-modified dextrans, hydroxymethylcellulosetrimethylamine, lysozyme, polylysine, protamine sulfate, hydroxyethylcellulosetrimethylamine and proteins at an appropriate pH. Examples of synthetic polycations include polyallylamine, poly(allylamine hydrochloride) (PAH), polyamines, polyvinylbenzyltrimethylammonium chloride, polybrene, polydiallyl-dimethylammonium chloride (PDADMAC), polyethyleneimine, polyimidazoline, polyvinylamine, polyvinylpyridine, poly(acrylamide/methacryloxypropyltrimethylammonium bromide), poly(diallyldimethylammonium chloride/N-isopropylacrylamide), poly(dimethylaminoethyl acrylate/acrylamide), polydimethylaminoethyl methacrylate, polydimethylaminoepichlorohydrin, polyethyleneiminoepichlorohydrin, polymethacryloyloxyethyltrimethylammonium bromide, hydroxypropylmethacryloyloxyethyidimethylammonium chloride, poly(methyldiethylaminoethyl methacrylate/acrylamide), poly(methyl/guanidine), polymethylvinylpyridinium bromide, poly(vinylpyrrolidone-dimethylaminoethyl methacrylate) and polyvinylmethylpyridinium bromide.

In embodiments, the neutral polymer can be a polysaccharide, cellulose derivative or synthetic polymer. Examples of polysaccharides include starch, glycogen, glucans, fructans, mannans, galactomannas, glucomannas, galactans, abrabinans, xylans, glycuranans, guar gum, locust, bean gum, dextran, starch amylose, and starch amy lopectin. Examples of cellulose derivatives include methylcellulose, hydroxyethylcellulose, ethylhydroxyethyl cellulose, and hydroxpropyl cellulose. Examples of synthetic polymers include polyvinylpyrrolidone, polyvinyl alcohol (PVA), ethylene oxide polymers, polyamides, polyesters, polyvinyl chlorides, ethylene-vinyl acetate copolymers, acrylonitrile copolymers, polyethylene tetrafluoride, polyvinylidene fluoride, polyethylene, polypropylene, ethylene-vinyl acetate copolymer, polyvinyl acetate, polyvinylidene chloride, polyethylene tetrafluoride, polystyrene, polyacrylonitrile, polymethyl methacrylate, ethylene-acrylic acid copolymer, ethylene-methyl acrylate copolymer, propylene-vinyl chloride copolymer, ethylene vinyl alcohol copolymer, polyethylene terephthalate, polybutylene terephthalate, polycarbonate, polyamides, such as nylon, polyacetals, such as polyoxymethylene, polysulfone, polyphenylene oxide, polyether sulfone and polyphenylene sulfide, polyvinyl butyral, polyurethane, polystyrene, melimine, polypropylene, epichlorohydrin, bisphenol A, epoxy, bisphenol epoxy ester, trimellitic, epoxy ester, phenolic resins, acrylics, acrylonitrile butadiene styrene (ABS) thermoplastic polymers, cellulose, polyvinyl alcohol, poly(2-ethyl-2-oxazoline), polyethylene glycols, and polylactic acids.

In embodiments, the sacrificial template can be a track-etch membrane, self-assembled membrane, phase inversion membrane, inorganic membrane or ceramic membrane. Examples of track-etch membranes include polycarbonate membrane (PCTE), polyimide membrane, polystyrene membrane, and polyester (polyethylene terephthalate) membrane. Examples of self-assembled membrane include polyisoprene-b-polystyrene-b-poly(4-vinylpyridine), poly(isoprene-b-styrene-b-N,N-dimethylacrylamide) (PI-PS-PDMA), poly(methyl methacrylate-r-trimethylsilyl)prop-2-ynyl methacrylate)-b-poly(4-bromostyrene) (P(MMA-r-TMSPYMA)-PBrS), polystyrene-b-polybutadiene-b-polystyrene (PS-PB-PS), polystyrene-b-polyethylene glycol (PS-PEO), polystyrene-b-polymethylmethacrylate (PS-PMMA), poly(styrene-co-acrylonitrile)-b-poly(ethyleneoxide)-b-poly(styrene-co-acrylonitrile) (PSAN-PEO-PSAN), poly(methyl methacrylate)-block-poly (n-octadecyl methacrylate) (PMMA-b-PODMA), polyethylene-block-polystyrene (PE-PS), poly(tert-butyl acrylate)-block-poly(2-cinnamoylethyl methacrylate) (PtBA-PCEMA), polystyrene-b/ock-polylactide (PS-PLA), polystyrene-block-poly(dimethylacrylamide) (PS-PDMA), polystyrene-block-poly(4-vinylpyridine) (PS-P4VP), and polystyrene-block-poly(dimethyl acrylamide)-block-polylactide (PS-PDMA-PLA). Examples of phase inversion membranes include nylon membrane, cellulose ester membrane, cellulose acetate membrane, polyamide membrane, polypropylene membrane, polyacrylonitrile membrane, polysulfone membrane, polyethersulfone membrane, polyvinylidiene fluoride membrane, polyethylene membrane, and polyvinyl chloride membrane. Examples of inorganic and ceramic membranes include silver membrane filter, glass fiber membrane filter, anodized aluminum oxide (AAO) membrane, silicon membrane, silicon nitride membrane, silicon carbide membrane, titania membrane, and zirconia membranes.

The solvent for dissolving the sacrificial template can be any suitable inorganic or inorganic solvent. In embodiments, the solvent can be an ester, ketone, alcohol, ether, acid or base. Examples include dimethylformamide, tetrahydrofuran, acetone, amyl acetate, aniline, anisole (methyoxybenzene), benzyl alcohol, butylene glycol, ethyl ether, butylene glycol n-butyl ether, diacetone, diasic ester, diethylene glycol butyl ether, diglyme, n-propylamine, 1,2-cyclohexane carbonate, hydrocarbons, halogenated hydrocarbons, toluene, xylene, amyl acetate, trichlorethylene, petroleum ether, paraffin, turpentine, cyclhexylamine, diethyl carbonate, methylene chloride, quinoline, 1,1,2,2-tetrachlorethane, 1,4-diaxane, methylene chloride, methyl ethyl ketone, ethyl benzene, chloroform, carbon disulfide, carbon tetrachloride, cyclohexanone, acetophenone, ethylene glycol, butyl ether acetate, benzene, carbon tetrachloride or decalin mesitylene, pyridine, quinoline, tetrahydrofurfuryl alcohol, amyl acetate, butylene glycol ethyl ether, butylenes glycol methyl ether, acetophine, cumene (isopropylbenzene), diethyl phthalate, acetic acid, allyl alcohol, butylene glycol n-propyl ether, hexanol (2-methyl-1-pentanol), propylene glycol isopropylether, cyclohexylamine, tetralin, xylene, acetophenone, o-xylene, tetralin, mineral spirits, acetophenone, methylene chloride, dioxane, dimethyl sulfoxide, N,N-dimethylacetamide, trichloroethane, nitrobenzene, methanol, ethanol, isopropanol, sodium hydroxyde, ammonium hydroxide, sulfuric acid, nitric acid, and formic acid.

In embodiments, the polymers in the polymeric inks are dissolved in water. In other embodiments, the solvent for dissolving the polymer can be any suitable inorganic or inorganic solvent. Examples of organic solvents for dissolving the polymers include dimethylformamide, tetrahydrofuran, acetone, amyl acetate, aniline, anisole (methyoxybenzene), benzyl alcohol, butylene glycol, ethyl ether, butylene glycol n-butyl ether, diacetone, diasic ester, diethylene glycol butyl ether, diglyme, n-propylamine, 1,2-cyclohexane carbonate, hydrocarbons, halogenated hydrocarbons, toluene, xylene, amyl acetate, trichlorethylene, petroleum ether, paraffin, turpentine, cyclhexylamine, diethyl carbonate, methylene chloride, quinoline, 1,1,2,2-tetrachlorethane, 1,4-diaxane, methylene chloride, methyl ethyl ketone, ethyl benzene, chloroform, carbon disulfide, carbon tetrachloride, cyclohexanone, acetophenone, ethylene glycol, butyl ether acetate, benzene, carbon tetrachloride or decalin mesitylene, pyridine, quinoline, tetrahydrofurfuryl alcohol, amyl acetate, butylene glycol ethyl ether, butylenes glycol methyl ether, acetophine, cumene (isopropylbenzene), diethyl phthalate, acetic acid, allyl alcohol, butylene glycol n-propyl ether, hexanol (2-methyl-1-pentanol), propylene glycol isopropylether, cyclohexylamine, tetralin, xylene, acetophenone, o-xylene, tetralin, mineral spirits, acetophenone, methylene chloride, dioxane, dimethyl sulfoxide, N,N-dimethylacetamide, trichloroethane, nitrobenzene, methanol, ethanol, isopropanol, and sodium hydroxide.

In another aspect of the invention, we describe an efficient method to fabricate functional mosaic membranes (i.e., charge mosaics) using a combination of inkjet printing and template synthesis. Utilizing a combined inkjet printing and template synthesis technique, one can prepare charge mosaic membranes in a rapid and straightforward manner, and produce unique transport properties that result from the mosaic membrane design. Poly(vinyl alcohol) (PVA) based composite inks containing poly(diallyldimethylammonium chloride) (PDADMAC) or poly(sodium 4-styrenesulfonate) (PSS) can be used to pattern positively-charged or negatively-charged domains, respectively, on the surface of a polycarbonate track-etched membrane with about 30 nm pores. The ability to control the net surface charge of the mosaic membranes through the rationale deposition of the oppositely-charged materials is demonstrated herein, and confirmed through nanostructural characterization, electrokinetic measurements, and piezodialysis experiments. Namely, mosaic membranes that possessed an overall neutral charge (i.e., membranes that had equal coverage of positively-charged and negatively-charged domains) are capable of enriching the concentration of potassium chloride in the solution that permeated through the membrane. These membranes can be deployed in the many established and emerging nanoscale technologies that rely on the selective transport and separation of ionic solutes from solution. Furthermore, because of the flexibility provided by the membrane fabrication platform, the efforts reported in this patent can be extended to other mosaic designs with myriad other functional components. We can utilize layer-b-layer (LbL) techniques or interconnected networks. We generally utilize a vacuum, but do not need to dissolve the template.

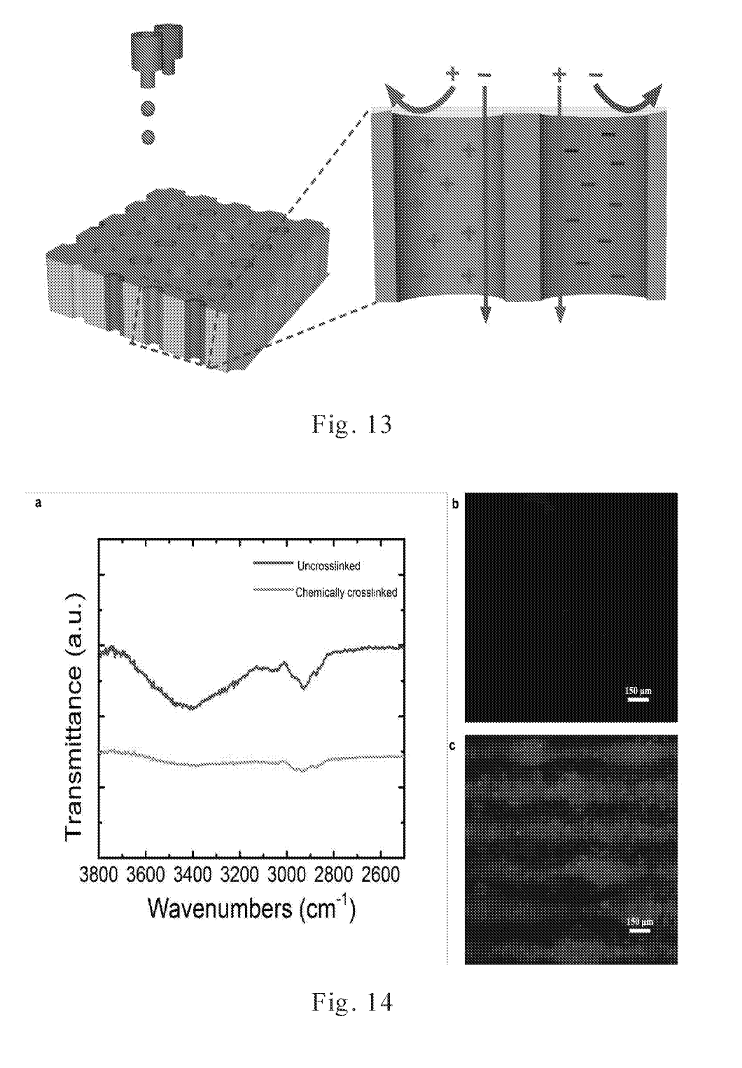

Charge mosaic membranes (FIG. 13) possess arrays of both positively and negatively charged domains. The juxtaposition of the counter-charged domains allows both cations and anions to permeate through the charge-functionalized membrane without violating the macroscopic constraint of electroneutrality, which greatly enhances the overall permeability of electrolytes. FIG. 13 displays a schematic diagram of the inkjet printing process described herein to fabricate charge mosaic membranes. The charge mosaic membranes consist of distinct cationic (green (left side of inset)) and anionic (purple (right side of inset)) domains that traverse the membrane thickness. The cationic domains allow the passage of anions, but restrict cations from passing, while the anionic domains allow the passage of cations, but restrict anions from permeating. Polymer composite inks that contain polyelectrolytes can be printed on a template surface to generate membranes with a charge mosaic structure. Membranes with this unique structure can transport dissolved salts more rapidly than similarly-sized neutral solutes and/or solvents.

In the method to fabricate functional mosaic membranes, the polyelectrolytes, neutral polymers, sacrificial templates, and solvents (for dissolving the template and dissolving the polymer) can be any of the chemicals described above for the method to fabricate nanomaterials.

The use of inkjet printing in the preparation of functional membranes has been limited. In this patent, we describe a novel combination of inkjet printing and template synthesis that addresses the materials processing issues that have hindered the development of charge mosaic membranes and enables the straightforward fabrication of mosaics with well-defined and well-controlled surface patterns from a diversity of materials chemistries.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise.

The claims may be drafted to exclude any optional element. This statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “at least one” and “one or more” are readily understood by one of skill in the art, particularly when read in context of its usage.

The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values (e.g., numbers recited in weight percentages and material sizes) proximate to the recited range that are equivalent in terms of the functionality of the individual ingredient, material, composition, or embodiment. The term about can also modify the end-points of a recited range as discussed above in this paragraph.

As will be understood by the skilled artisan, all numbers, including those expressing sizes of materials, quantities of ingredients, and properties, such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited herein are for illustration only and do not exclude other defined values or other values within defined ranges.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “polymer” means a large molecule, or macromolecule, composed of many repeated subunits, from which originates a characteristic of high relative molecular mass and attendant properties.

An “effective amount” or “sufficient amount” refers to an amount effective (or sufficient) to bring about a recited effect, such as an amount necessary to form products in a reaction mixture. Determination of an effective (or sufficient) amount is typically within the capacity of persons skilled in the art, especially in light of the detailed disclosure provided herein. The term “effective (or sufficient) amount” is intended to include an amount of a compound or reagent described herein, or an amount of a combination of compounds or reagents described herein, e.g., that is effective (or sufficient) to form products in a reaction mixture. Thus, an “effective (or sufficient) amount” generally means an amount that provides the desired effect.

“Polyelectrolytes” are polymers whose repeating units bear an electrolyte group. Polycations and polyanions are polyelectrolytes. These groups dissociate in aqueous solutions (water), making the polymers charged. Polyelectrolyte properties are thus similar to both electrolytes (salts) and polymers (high molecular weight compounds) and are sometimes called polysalts. Like salts, their solutions are electrically conductive. Like polymers, their solutions are often viscous.

“Inkjet printing” is a type of computer printing that recreates a digital image by propelling droplets of ink onto paper, plastic, or other substrates. As defined herein, inkjet printing includes the electrohydrodynamic jet (e-jet) printing method. An e-jet printer works by pulling ink droplets out of the nozzle rather than pushing them, allowing for smaller droplets.

An electric field at the nozzle opening causes ions to form on the meniscus of the ink droplet. The electric field pulls the ions forward, deforming the droplet into a conical shape. Then a tiny droplet shears off and lands on the printing surface. A computer program controls the printer by directing the movement of the substrate and varying the voltage at the nozzle to print a given pattern.

“Mosaic membranes” possess discrete arrays of chemical domains.

The design and operation of nanomaterials (i.e., nanotubes and nanowires), films, and functional mosaic membranes (i.e., charge mosaic membranes) fabricated via the combination of inkjet printing and template synthesis was demonstrated in the following Examples. The following Examples are intended to illustrate the above invention and should not be construed as to narrow its scope. One skilled in the art will readily recognize that the Examples suggest many other ways in which the invention could be practiced. It should be understood that numerous variations and modifications can be made while remaining within the scope of the invention as defined in the claims.

### EXAMPLES

### Materials

I. Polymeric Nanotubes, Nanowires, and Thin Films

Polycarbonate track-etched (PCTE) membranes (pore diameter: 50 nm and 200 nm; membrane thickness: 10 μm; porosity: ˜3×10⁸ pores cm⁻²) were purchased from Whatman. Non-woven membranes (Cranemat, CU 414) were purchased from Crane & Co., Inc. 15 kDa and 120 kDa poly(allylamine hydrochloride) (PAH), fluorescein isothiocyanate-labeled poly(allylamine hydrochloride) (FITC-PAH), 70 kDa poly(styrenesulfonate) (PSS), 1000 kDa poly(ethylene oxide) (PEO), (3-aminopropyl)triethoxysilane (APTES), sodium chloride, sodium sulfate, magnesium sulfate, magnesium chloride, copper chloride, and potassium permanganate were purchased from Sigma Aldrich and used as received. The water used in all experiments was obtained from a Millipore water purification system.

II. Polymeric Charge Mosaic Membranes

Polycarbonate track-etched (PCTE) membranes (pore diameter: 30 nm) were purchased from Whatman. Poly(vinyl alcohol) (PVA) powder (98-99% hydrolyzed), poly(diallyldimethylammonium chloride) (PDADMAC, M_{w}<100,000), poly(sodium 4-styrenesulfonate) (PSS, 70 kDa) fluorescein isothiocyanate-labeled poly(allylamine hydrochloride) (FITC-PAH), 37% (by volume) hydrochloric acid, 25% (by weight) glutaraldehyde, and potassium chloride were purchased from Sigma Aldrich and used as received. Sulfo-Cyanine5 (Cy5) was purchased from Lumiprobe. The acrodisc 25 mm syringe filter fitted with a 1 μm glass fiber membrane was purchased from Pall corporation. The water used in all experiments was obtained from a Millipore water purification system.

### Equipment

I. Modification of the Inkjet Printer

An Epson WorkForce 30 Inkjet Printer was modified for the experiments. The lid sensor was taped so that the printer lid could remain open during the printing process. Plastic and metal guide wheels from the front of the printer and the middle paper roller section were removed so the membrane templates would not get scratched as they passed underneath. The waste tube was pulled out from its original position and guided to the front of the printer where a waste collection tube was added. This allowed waste generated from cleaning the print head to be collected rather than emptied into the back of the printer. Both the printer lid and the cartridge cover were removed from the setup so a continuous ink supply system made by CISinks could be installed.

To print a membrane with multiple layers, where a layer consists of a single color, the layout of the print head needs to be understood because only one color can be printed at a time when sending raster data to the printer. The vertical positioning of the print head can only move down a page. It cannot go back to a position above the current print position. Therefore, grey and cyan must be printed first, then black, magenta, and yellow. The program built the raster data based on the location of the print head. Whenever the print head was in a location where a certain color should be printed, that color was be printed. The maximum number of nozzles was used at all times to increase the efficiency. If multiple colors could be printed at the same print head location, the printing order was based off of the layer order specified by the user of the program. Users of the program entered position and dimension variables as well as the color and number of coats for each specified layer. Resolution and dot size were also specified by the user. Data was sent to the printer in bytes corresponding to the commands of the ESC/P printer language.

A vacuum device was fabricated by fixing two plastic sheets together using double-sided Scotch brand tape. Approximately a 1 cm×1 cm hole and about a 0.2 cm×0.2 cm hole were cut on the top sheet. A plastic tube was inserted into the smaller hole and sealed with Epoxy (3M, DP8010). The vacuum device was connected to an in-house vacuum system though a plastic tygon tube and a digital pressure transducer (Omega Engineering, PX409) was used to monitor the vacuum pressure.

### Testing Protocols

I. Characterization of Nanotubes with Scanning Electron Microscopy

The printed nanostructures (i.e., PAH/PSS nanotubes) were imaged using a FEI-Magellan 400 field-emission scanning electron microscope. For nanotubes and nanowires, the printed template membrane was plasma etched to remove any residual polymer on the upper and lower surfaces of the membrane. The membrane was attached to an APTES-treated glass slide and put in an oven at about 100° C. for about one hour. Subsequently, the membrane template was dissolved in dichloromethane and the glass slide was rinsed with ethanol. About 2 nm of Iridium was sputtered on the nanotubes by a Cressington sputter coater 208 HR to prevent sample charging during imaging.

II. Surface Charge Measurements of Printed Nanotubes

Streaming current measurements were used to determine the sign of the surface charge of the printed nanotubes. A PCTE membrane containing nanotubes was mounted between two halves of a U-tube cell. About 10 mM potassium chloride was filled in both halves of the cell. Pressure was applied to the side of the cell connected to the positive terminal of the source meter. As solution flows through the membrane, the surface charge restricts the passage of co-ions (i.e., ions with the same sign as the membrane charge), which results in a streaming current. The applied pressure was measured by a pressure transducer (Omega Engineering, PX409). The resulting current was measured with two Ag/AgCl wires by a Keithley 2400 source meter. Laboratory Virtual Instrument Engineering Workbench (LabVIEW) software was used to record both the value of the pressure and the current as a function of time (shown in FIG. 7).

III. Water Permeability and Ion Rejection Measurements for PAH/PSS Thin Films

The PAH/PSS thin film was put in a stirred cell (Amicon model 8003). Water was filled in the stir cell and a pressure of about 4 bar was applied to drive water through the membrane. The solution that permeated through the membrane was collected in a small beaker. The mass of the collected water was weighed over time using a balance and recorded by Laboratory Virtual Instrument Engineering Workbench (LabVIEW) software. The slope of the mass of collected water over time, the membrane area, and the applied pressure were used to calculate the hydraulic permeability of the membrane.

In ion rejection measurements, about 10 mM solutions of single salts (i.e., NaCl, MgCl₂, Na₂SO₄, MgSO₄) were used as the feed solutions. A pressure of about 4 bar was applied to drive flow. The solution that permeated through the membrane was collected in a glass beaker. The concentration of ions in the feed and permeate solutions was analyzed using ion chromatography (Dionex ICS-5000). The measured concentrations were used to calculate the percent rejection, R, according to Equation (1):

$$R ( \% ) = ( 1 - \frac{{c}_{P}}{{c}_{F}} ) \times 100 \qquad ( 1 )$$

where cₚ and c_{f} is the concentration of ions measured in the permeate and the feed, respectively.

### Example 1: Layer-by-Layer (LbL) Inkjet Printing of PAH/PSS Nanotubes

Repeated deposition of PAH and PSS polyelectrolytes was used to fabricate nanotubes. Aqueous solutions of the polyelectrolytes at about 20 mM (based on repeat unit molecular weight) with 0.5 M NaCl as a supporting electrolyte were prepared. The pH of the PAH solution was adjusted to about 5.5 using 1 M HCl; the pH of the PSS solution was unadjusted. The cyan and magenta cartridges were filled with the PAH and PSS solution, respectively. The black and yellow cartridges were filled with DI water. A PCTE membrane with a pore diameter of about 200 nm was used as a template. The PCTE membrane with a non-woven membrane underneath was put over an approximately 1 cm×1 cm hole of the vacuum device. The non-woven membrane supports the PCTE templates during printing. This support helps to promote an even flow distribution through the pores of the template by preventing the template from contacting the impermeable plastic sleeve of the vacuum device. The four sides of the PCTE membrane were sealed with tape and a constant vacuum of about 12 psig was applied throughout the printing process. An ESC/P code was written to print a 1 cm×1 cm square. Four cartridges were used for printing nanotubes and programmed to print in the following order: PAH solution was printed first from the cyan cartridge, followed by printing water from the black cartridge. Then, PSS solution was printed from magenta cartridge, followed by printing water from the yellow cartridge.

Printing from the four cartridges completed one printing cycle and resulted in the formation of one bilayer (PAH/PSS)₁ inside the pores of the PCTE membrane. The number of PAH/PSS bilayers was controlled by the number of programmed printing cycles. Another input of the program is the number of overprints, which is the number of times that the printer ejects a droplet of ink at the same location. In this example, 20 overprints of the PAH and PSS solutions were applied and 40 overprints of water were used for rinsing. Five PAH/PSS bilayers, (PAH/PSS)₅, were printed in the PCTE membrane. After printing, the membrane was dried in an oven at about 100° C. for about one hour.

### Example 2: Inkjet Printing of Polyvinyl Alcohol) (PVA) Nanowires and Nanotubes

About a 0.3 wt % aqueous solution of poly(vinyl alcohol) (PVA) solution was used to print nanowires and nanotubes. A PCTE membrane with pores about 200 nm in diameter was used as a substrate. The PCTE template with a non-woven membrane underneath was fixed in the vacuum device by putting it over the large hole of the vacuum device, and the four sides of the membrane were sealed with tape. A constant vacuum of about 12 psig was pulled on the bottom of the membrane throughout the printing process. Twenty overprints of the PVA solution were applied over approximately a 1 cm×1 cm square to prepare the PVA nanowires, whereas five overprints of the PVA solution were used to make the PVA nanotubes. After the printing was completed, the membrane template was put in the oven at about 100° C. for about one hour.

### Example 3: Inkjet Printing of PAH/PSS Thin Films

The films can be of any thickness, from thick to thin, such as micron-sized to nano-sized. Aqueous solutions of PAH and PSS at about 20 mM (based on repeat unit molecular weight) with 0.5 M NaCl as a supporting electrolyte or with no supporting electrolyte were prepared. The pH of the solutions was unadjusted. A PCTE membrane with pores about 50 nm in diameter was used as a permeable substrate for the printed PAH/PSS thin films so that their performance as nanofiltration membranes could be evaluated. Porous PCTE membranes were used as substrates due to their well-defined pore structures and narrow pore size distributions. Depending upon the ultimate application of the thin films, they could also be printed on a non-porous flat surface, as demonstrated by Andres, C. M.; Kotov, N. A.; Inkjet Deposition of Layer-by-Layer Assembled Films, J. Am. Chem. Soc. (2010), 132, pages 14496-14502.

An ESC/P printer language was written to print 1.5 cm×1.5 cm square of PAH solution with 3 overprints to the membrane. The membrane was allowed to dry and rinsed with water. Because no vacuum was applied during the fabrication of thin films, the samples were dried between deposition steps to prevent the excessive accumulation of solution on the PCTE membrane surface. The rinsing step has been demonstrated to rinse away loosely bound polyelectrolyte and stabilize the layer-by-layer film. Additionally, a similar film-preparation route that omitted the rinsing step resulted in thin films covered with crystalized salt. The process was repeated with the PSS, where the membrane was printed by PSS solution with 3 overprints, followed by drying the membrane and rinsing it with water. The printing of PAH and PSS completed one printing cycle and resulted in one bilayer of (PAH/PSS)₁ on top of the PCTE membrane. The number of bilayers was controlled by the number of printing cycles. After printing, the membrane was put in the oven at about 100° C. for about one hour. The PCTE membrane was not dissolved when PAH/PSS thin films were fabricated.

### Example 4: Printing Patterns

A 20 mM solution of FITC-labeled PAH with 0.5 M sodium chloride as a supporting electrolyte was used to print patterned layer-by layer (LbL) structures. A PCTE membrane with about 200 nm diameter pores was used as the template. Four bilayers of PAH and PSS were deposited within the PCTE template using the process detailed above for printing PAH/PSS nanotubes. Chemical patterns were then printed using the FITC-PAH as the terminal layer. The membrane was rinsed between deposition steps, but not dried. Three different patterns were printed on the PCTE membrane: (1) dots, (2) stripes, and (3) the ND logo.

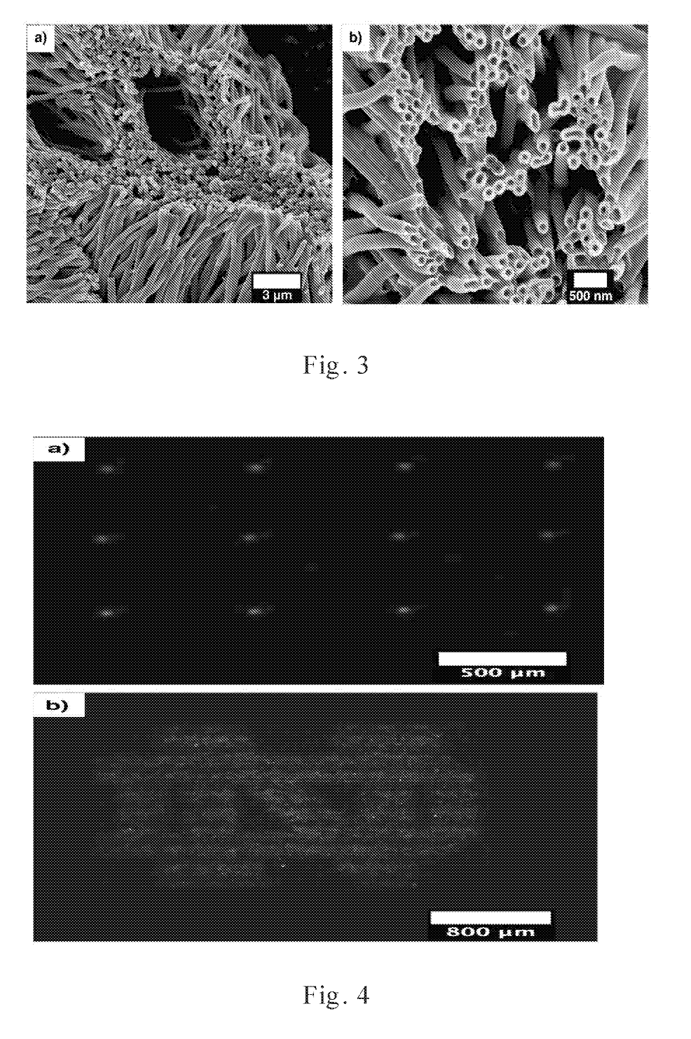

To print arrays of individual dots, as shown in (a) of FIG. 4, the printer was programmed to print one overprint of the FITC-labeled PAH solution in a 1 cm×1 cm square with 45 dpi. Approximately a 0.3 wt % solution of PVA mixed with about 5 mM FITC-labeled PAH and about a 0.05 wt % aqueous solution of PEO were used as inks when printing stripes of PVA nanowires with interstitial gaps. The PAH provides functionality and the PVA provides structure to the inks. The PEO washes away easily. PCTE membranes with pores of about 200 nm in diameter were used as substrates. Twenty overprints were used and the membranes were put in an oven at about 100° C. for about one hour after printing. The membranes were then laid flat onto an APTES-treated glass slide and put in oven at about 100° C. for about another hour. Heating crosslinks the APTES and helps to affix the nanowires to the glass slide, which makes the subsequent imaging analysis easier to execute. Finally, the PCTE templates were dissolved in dichloromethane and the samples were taken for imaging by fluorescent and SEM microscopy. For printing alternating stripes of different chemical compositions, approximately a 2 wt % solution of PVA mixed with about 6 mM PAH and about 100 mM potassium permanganate and about a 2 wt % solution of PVA mixed with about 6 mM PSS and about 100 mM copper chloride were used. Twenty (or fifteen) overprints were used and the membranes were put in an oven at about 100° C. for about one hour after printing. The number of overprints depend upon the application. Generally, more overprints are required to fabricate nanowires than for nanotubes. The membranes were then laid flat onto an APTES-treated glass slide and put in oven at about 100° C. for about another hour. Heating crosslinks the APTES and helps to affix the nanotubes to the glass slide, which makes the subsequent imaging analysis easier to execute. Finally, the PCTE templates were dissolved in dichloromethane and the samples were taken for imaging by fluorescent and SEM microscopy. A digital image of the ND logo with 2.5 μm length was hand drawn in the iDraw graphics software and used for printing the ND logo on the PCTE membrane. The best printing quality was used for printing the ND logo. The printed patterns were visualized in an EVOS fluorescent microscope with the GFP light cube.

### Example 5: Inkjet Printing of PVA Stripes

Approximately a 0.3 wt % solution of PVA mixed with 5 mM FITC-labeled PAH and about a 0.05 wt % aqueous solution of polyethylene oxide (PEO) were used as inks. PCTE membranes with pores about 200 nm in diameter were used as substrates. An ESC/P printer language was written to print alternating stripes of PVA and PEO. The length of the stripes was set at about 1.1 cm, and the widths were varied. Twenty overprints were used, and the membrane was put in an oven at about 100° C. for about one hour after the printing. The membrane was then transferred to an APTES-treated glass slide and put in oven at about 100° C. for another hour. Finally, the membrane was dissolved in dichloromethane and taken for imaging by fluorescent and SEM microscopy. PEO was used as filler to prevent the APTES solution from entering the pores of PCTE membrane template. After fixing the template to a glass slide using APTES, the PEO dissolved in dichloromethane during the removal of the template, which generated the gaps between the stripes of PVA. If PEO was not implemented, undesired APTES nanostructures that complicated analysis of the printed patterns would form.

### Results and Discussion of Polymeric Nanotubes, Nanowires, and Thin Films

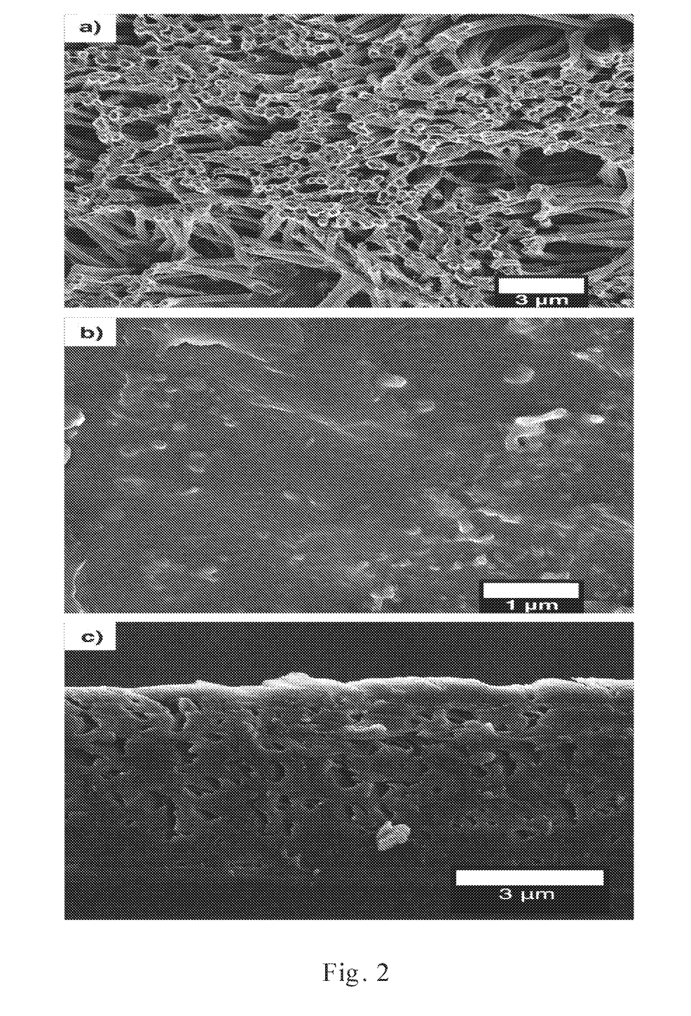

FIGS. 2 and 3 display SEM micrographs of different nanostructures generated when combining template synthesis with an inkjet printing process. FIG. 2 shows SEM micrographs of printed PAH/PSS nanostructures. In (a) of FIG. 2, nanotubes were prepared by printing PAH and PSS sequentially in a PCTE membrane with pores that are about 200 nm in diameter while pulling a constant vacuum of about 12 psig on the downstream side of the membrane. The PCTE membrane template was dissolved in dichloromethane to liberate the nanotubes. In (b) and (c) of FIG. 2, top and cross-sectional views are shown, respectively, of thin films that were fabricated by printing five PAH/PSS bilayers on top of a PCTE membrane with pores that are 50 nm in diameter. In (a) of FIG. 2, a SEM micrograph is shown of the printed layer-by-layer (LbL) PAH/PSS nanotubes. With a constant vacuum of 12 psig applied, PAH and PSS were printed sequentially on a PCTE membrane with a pore diameter of about 200 nm. The number of droplets ejected at one location during each pass of the print head over the PCTE surface (defined as the number of overprints in this report) was set to twenty. With vacuum applied during this process, no accumulation of printed solution on the PCTE surface was observed by visual inspection. The process was repeated five times in order to deposit five bilayers of PAH/PSS inside the pores. After dissolving the PCTE template, the outer diameter of the nanotubes in (a) of FIG. 2 is 220 nm±20 nm, which is in good agreement with the pore size of the template. The thickness of the nanotube wall is 70 nm±10 nm, which is comparable to that of nanotubes prepared by the dip coating method, indicating that the nanotubes formed by dip coating and inkjet template synthesis are structurally similar.

The vacuum assisted deposition of polyelectrolyte is faster compared to the diffusion-based dip coating method. It takes less than about 17 minutes to print one PAH/PSS bilayer in a 1 cm×1 cm template using inkjet printing. In comparison, it takes at least 50 minutes to deposit a bilayer of the same material using dip coating methods. Additionally, the volume of polyelectrolyte solution used to print a 1 cm×1 cm membrane with 5 bilayers of PAH/PSS (˜1 μL per layer) is significantly less than that used in standard dip coating methods (˜5-10 mL per layer). The more efficient use of materials in the inkjet printing process has the additional benefit of reducing the effort needed to rinse away loosely absorbed polyelectrolytes. Lastly, because the printer executes the deposition of the bilayers, the manual labor required is greatly reduced.

In the absence of an applied vacuum, the layer-by-layer (LbL) polyelectrolyte thin film is printed on top of the PCTE membrane. In (b) of FIG. 2, SEM micrographs are shown of a PAH/PSS thin film printed on a PCTE membrane with pores about 50 nm in diameter. The top-view image demonstrates that all pores of the PCTE template are completely blocked and covered by a thin film. The cross-sectional view ((c) of FIG. 2) does not show a clear boundary between the thin film and the PCTE membrane, but the thickness of the thin film is less than about 200 nm. The time it takes to print 1 layer of PAH or PSS with 3 overprints is about 40 seconds.

The concept of inkjet printing in template membranes can be extended to other polymeric materials and other nanostructures. FIG. 3 shows SEM micrographs of (a) PVA nanowires and (b) PVA nanotubes. In (a) of FIG. 3, nanowires were prepared by printing 20 overprints of PVA in a template with about 200 nm pore diameter, while pulling a constant vacuum of about 12 psig on the downstream side of the membrane. In (b) of FIG. 3, nanotubes were prepared by printing 5 overprints of PVA in a template with about 200 nm pore diameter, while pulling a constant vacuum of about 12 psig on the downstream side of the membrane. The PCTE membrane was dissolved in dichloromethane prior to SEM characterization. In (a) of FIG. 3, an SEM micrograph is shown of PVA nanowires that were printed in a PCTE membrane with pores about 200 nm in diameter. The fabrication of these nanowires highlights the concept that simple changes in the printing process can change the ultimate nanostructure of the deposited material. PVA nanotubes can be prepared by applying five overprints of the PVA solutions onto a PCTE template ((b) of FIG. 3). By increasing the numbers of overprints to 20, nanowires were fabricated instead of nanotubes. Even though the nanowires fill the pore volume of the template, no accumulation of the printed solution was observed on the PCTE surface when printing the nanowires. In a process where only a single material is being deposited, printing nanowires over a 1 cm×1 cm area takes under 3 minutes (about 170 seconds) and printing nanotubes over the same area takes under 1 minute (about 45 seconds).

Combining ink-jet printing and template synthesis enables control over the spatial distribution of nanomaterials. A significant advantage of using inkjet printing to fabricate polymeric nanomaterials is the ability to control the spatial distribution of domains of unique chemical design over the surface of the substrate. This allows nanomaterials of varying chemical composition to be fabricated and oriented next to each other with relative ease. We demonstrated this ability by printing patterns of dots and an ND logo (shown in FIG. 4) that consist of nanotubes or nanowires. In these experiments, a fluorescein isothiocyanate-labeled PAH (FITC-PAH) was used so that the domains are visible in a fluorescent microscope. Printing dots (shown in FIG. 4) and stripes (see text below and shown in FIG. 5) was accomplished by writing a program in Epson Standard Code for printers (ESC/P).

FIG. 5 illustrates the spatial control and selective deposition of functional nanomaterials using the methods described herein. A PCTE membrane with about 200 nm pore diameter was implemented. In (a) of FIG. 5, the printer is programmed to print fluorescent PAH stripes with a width of about 200 μm and about 200 μm spacing. In (b) of FIG. 5, a higher magnification SEM micrograph is shown at the stripe-gap boundary of printed PVA nanowires. Approximately a 200 μm stripe width and about a 400 μm gap distance were used. The PCTE membrane was dissolved in dichloromethane prior to imaging. In (c) of FIG. 5, a SEM-EDX image is shown at the boundary of two approximately 200 μm PVA stripes. One stripe was printed from PVA blended with potassium permanganate and the other stripe was printed from PVA blended with copper chloride. Regions rich in manganese are shaded red (found mainly in the upper third of the image) and regions rich in copper are shaded green (found mainly in the lower two-thirds of the image). The PCTE membrane was dissolved in dichloromethane prior to imaging.

The combination of ink-jet printing with template synthesis provided control over surface functionality. The deposition of functional materials, such as polymers, proteins, dendrimers, inorganics, and biologics, has been explored for numerous potential applications including nanobiosensing, controlled release, and ionic separations. The inkjet template synthesis method described herein can be a viable method for processing functional materials into useful nanostructures as long as the materials retain their functionality upon deposition. We used the example of the layer-by-layer (LbL) assembly of polyelectrolytes in PCTE membranes to modify the surface charge of the nanotubes and demonstrated that the printed materials retain their functionality. Due to the residual charge on the dangling ends and loops associated with the innermost layer of deposited polycations or polyanions, the surface of a pore will possess either a positive or a negative charge, respectively. In order to demonstrate that inkjet template synthesis produces nanomaterials that retain their functionality, the surface charge modification of the layer-by-layer (LbL) assembled PAH/PSS nanotubes was studied using streaming current measurements.

The sign of the surface charge of the PAH/PSS nanotubes fixed within a PCTE template can be determined from streaming current measurements. The streaming current is generated by forcing a salt solution through a charged membrane, which sits between two solutions connected through an electrical circuit. The streaming current is a result of the requirement to maintain electro-neutrality. The ratio of the measured streaming current to the applied pressure used to drive flow is directly related to the surface charge inside the nanotubes. In the experimental design implemented here, because the positive terminal of the source meter is connected to the side of the cell where pressure is applied, the sign of the current:pressure ratio is opposite that of the surface charge, i.e., a negative surface charge in the nanotubes results in a positive value for the ratio and vice versa.

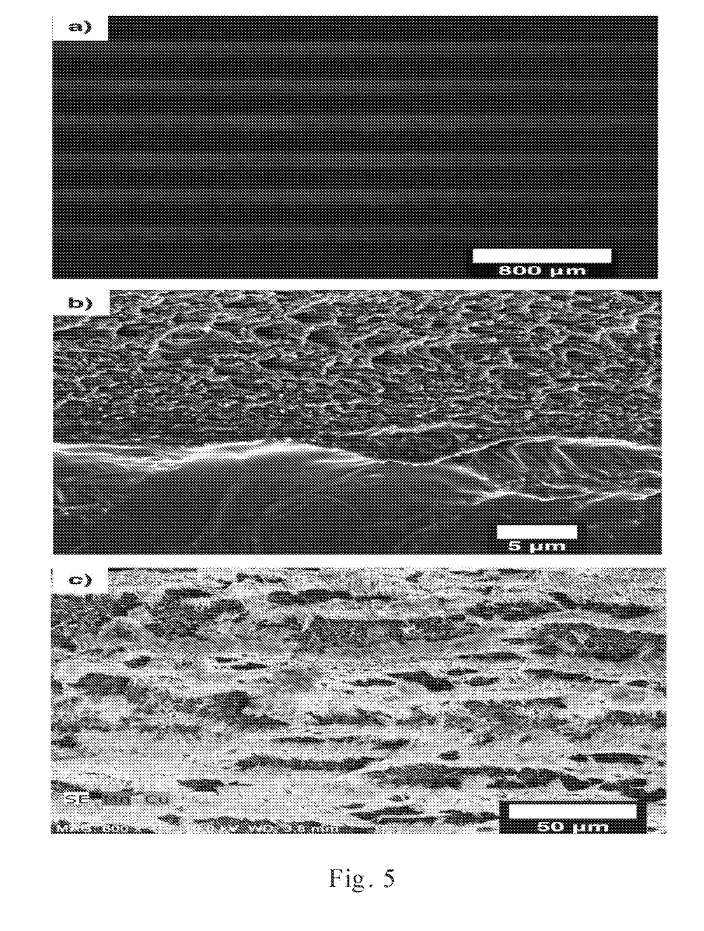

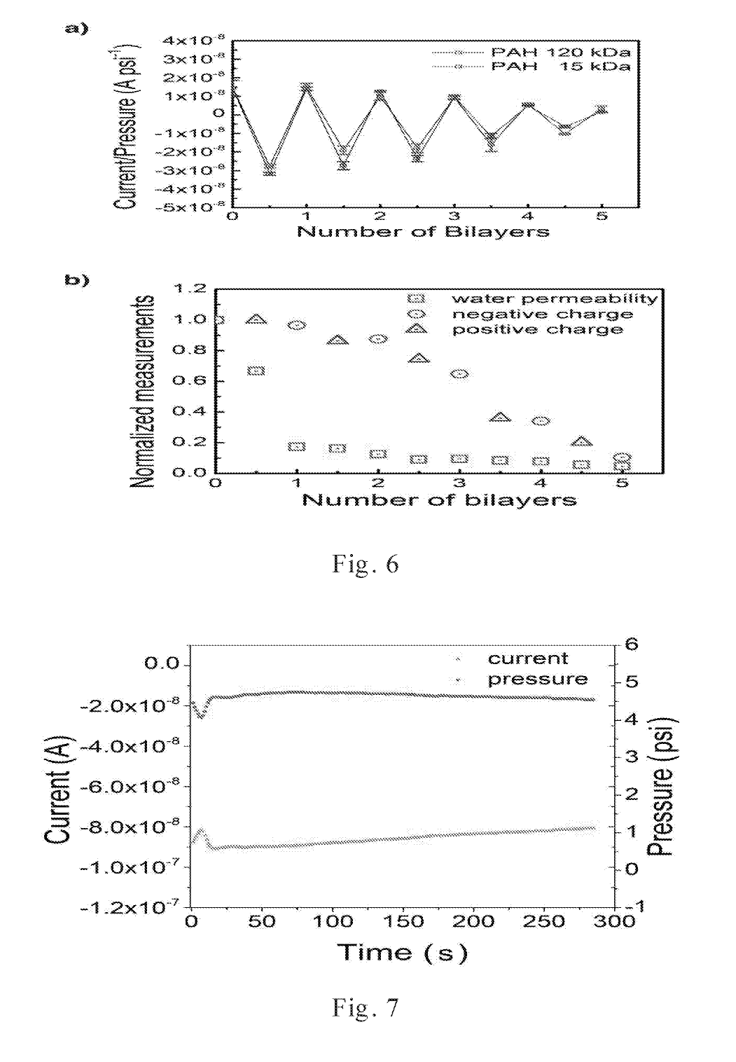

FIG. 6 shows the streaming current and water permeability versus the number of deposited bilayers for the layer-by-layer (LbL) printed nanotubes. In (a) of FIG. 6, nanotubes were fabricated by printing PAH (red squares: 120 kDa and blue squares: 15 kDa) and PSS on a PCTE template with about 200 nm diameter pores. The streaming current was measured using a 10 mM KCl solution adjusted to about pH 3. Pressure was applied on the side of the apparatus connected to the positive terminal of the source meter.

An example of the data collected from a streaming current measurement is shown in FIG. 7. Values of the applied pressure and streaming current were recorded using a computer as discussed above in section II of the Testing Protocols. The error bars represent the standard deviation between three measurements. In this experiment, a PCTE membrane with about a pore size of 200 nm in diameter was modified with 1.5 bilayers of PAH and PSS and placed between two cells containing 10 mM KCl solutions. Pressure was applied on the cell that was connected to the positive terminal of the source meter. The applied pressure and resulting current were monitored and recorded.

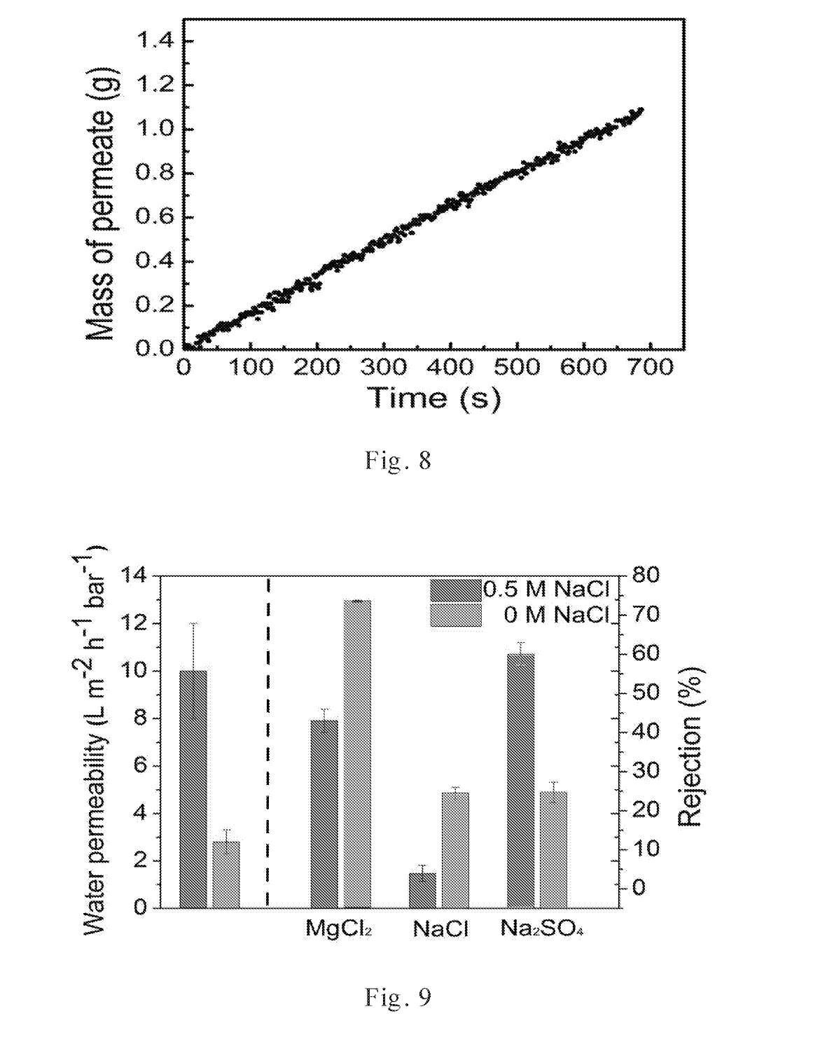

In (b) of FIG. 6, nanotubes were fabricated by printing PAH (15 kDa) and PSS on a PCTE template with about 200 nm diameter pores. The streaming current test was the same as described in (a) of FIG. 6, and the hydraulic permeability was measured in a stirred cell as shown in FIG. 8. The values of hydraulic permeability were normalized by the hydraulic permeability at PCTE template. The streaming current:applied pressure ratio were normalized by the ratio measured at 0.0 and 0.5 bilayer for the negative and positive values, respectively.

FIG. 6 displays how surface charge changes with printing of alternating layers of PAH and PSS in PCTE membrane templates. The parent PCTE membrane has residual negative charges due to a polyvinylpyrrolidone (PVP) coating applied during manufacturing. Every layer of PAH or PSS that was printed added 0.5 bilayers and should cause the surface charge within the nanotubes to switch signs. This is precisely what was observed in (a) of FIG. 6, where each addition of a half bilayer caused the streaming current:applied pressure ratio to alternate between a positive and negative value. Additionally, the magnitude of this ratio was the same as that measured and reported for polyelectrolyte nanotubes used to generate charge mosaic membranes. This result provides strong evidence that the combination of inkjet printing and template synthesis provides control over the surface charge of the nanotubes, which can subsequently be used for the fabrication of charge mosaic membranes.

It is interesting to note that the absolute value of the current:pressure ratio decreased slowly with the addition of more layers. The same decrease is observed if a 15 kDa or a 120 kDa PAH sample is used, which suggests that the decrease is not the result of steric hindrance preventing polyelectrolyte deposition. To investigate the cause of this decrease further, (b) of FIG. 6 plots the normalized hydraulic permeability of the membranes as well as normalized values of the current:pressure ratio as a function of increasing number of bilayers. The observed decrease in current could be caused by the addition of bilayers reducing the effective pore size and permeability of the nanotubes, or it could be caused by the ionic crosslinking between the PAH and PSS becoming more effective with the addition of each layer, which would result in less dangling ends and loops extending into the center of the nanotubes. The initial rapid drop in normalized hydraulic permeability within one bilayer suggests the rapid build up of PAH/PSS inside the pores. Subsequently, smaller changes in permeability are observed, which suggests smaller changes in the inner diameter of the nanotubes occur after the addition of 1 bilayer. On the other hand, the normalized values of the current:pressure ratio do not vary significantly for the 0.0 to 1.0 bilayer systems, but for systems with more than one bilayer deposited, the values of the current:pressure ratio decrease. Taken together, these data suggest rearrangement of the polyelectrolytes within the confined nanopores of the PCTE template, and the loss of dangling ends and loops caused by this rearrangement lead to the reduced current-pressure that was observed as more bilayers are added to the walls of the PAH/PSS nanotubes. As suggested in the literature, his polymer rearrangement of the PAH/PSS nanotubes in the pores of the PCTE membrane may result in the reduction of the membrane surface charge.

FIG. 8 shows the water permeability and ion rejection measurements for PAH/PSS thin films. The data was collected during water flux measurements. A thin film comprising 5 bilayers of PAH/PSS was printed onto a PCTE membrane template with about 50 nm pores. The PAH/PSS thin film was put in a stirred cell (Amicon model 8003). Water was filled in the stir cell and a pressure of about 4 bar was applied to drive water flow through the membrane. The solution that permeated through the membrane was collected in a small beaker. The mass of the collected solution was monitored and weighed over time using a balance and recorded by Laboratory Virtual Instrument Engineering Workbench (LabVIEW) software. The slope of the mass of collected solution (water) over time (e.g., FIG. 8), the membrane area, and the applied pressure were used to calculate the hydraulic permeability of the membrane.

The combination of ink-jet printing and template synthesis can generate functional nanomaterials. Multilayer thin films comprised of PAH/PSS can be fabricated by executing inkjet template synthesis in the absence of an applied vacuum. Such types of thin films generated using dip-coating layer-by-layer (LbL) have shown promise as nano-filtration membranes and selective coatings that enhance the efficacy of ion exchange membranes in eletrodialysis. These promising characteristics of layer-by-layer (LbL) thin films were retained when the constituent polyelectrolytes were deposited by inkjet printing as shown in FIG. 9.

FIG. 9 shows the water permeability and salt rejection of layer-by-layer (LbL) thin films prepared with 0 M NaCl and 0.5 M NaCl supporting electrolyte solutions. The first two columns display the water permeability, corresponding to the left y-axis. The remaining columns show salt rejection data and correspond to the right y-axis. PCTE membranes with about 50 nm pore diameters were used as the printing substrates. Five bilayers of PAH/PSS were printed on the PCTE membrane. All salt feed solutions for the rejection tests were 1000 ppm in concentration. An applied pressure of about 4 bar was used to drive solution flow. Error bars were obtained by three measurements with the same membrane.

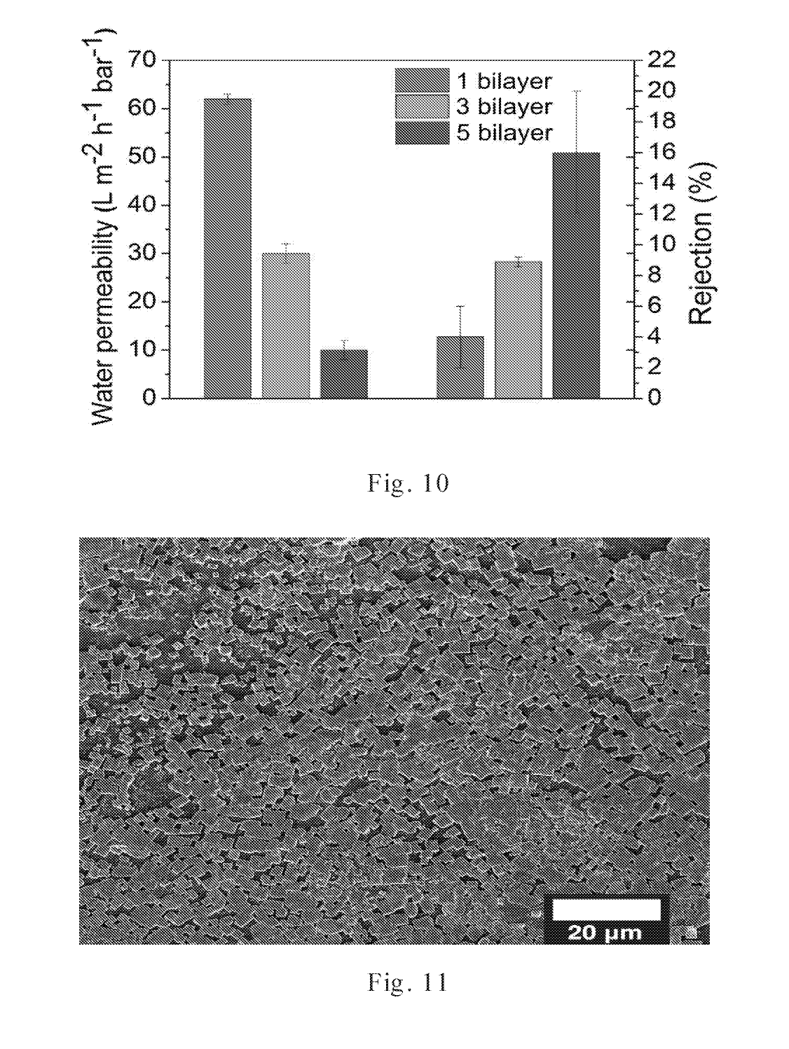

We tested the water permeability and ion rejection measurements for PAH/PSS thin films according to section III of the Testing Protocols discussed above. FIG. 10 shows the water permeability and rejection of magnesium sulfate with different numbers of PAH/PSS bilayers printed on a PCTE membrane with about 50 nm pore diameter. 0.02 M PAH and 0.02 M PSS were used as ink solutions, and both ink solutions contained 0.5 M sodium chloride. Error bars were obtained by three measurements with the same membrane. The hydraulic permeability of the printed thin film decreased as the number of PAH/PSS bilayers deposited increased (as shown in FIG. 10).

The concentration of supporting electrolytes used during the preparation of multilayer thin-films can influence the amount of salt rejected by the thin film. This has been reported in the case of thin films made by dip coating, and we observed the same to be true for thin films made by inkjet printing. FIG. 9 demonstrates the effect of supporting electrolytes on the ion rejection performance of the resulting thin films. One polymer ink was prepared with addition of 0.5 M NaCl and the other ink solution was prepared without the addition of any salt. The hydraulic permeability of a thin film prepared without a supporting electrolyte was lower than that of a membrane prepared with a 0.5 M NaCl. One possible explanation for this observation is that salt crystalizes within the thin film as it dries between printing steps (FIG. 11).

FIG. 11 shows a SEM micrograph of a PAH/PSS thin film covered with crystalized salt printed on a PCTE membrane template with pores about 50 nm in diameter. For this sample, no rinsing step was used between polyelectrolyte depositions. After applying three overprints of PAH on the PCTE membrane, the membrane was dried in air, followed by applying three overprints of PSS. After immersing the completed membranes in water, these salt crystals dissolved, but left cavities within the film that increased the hydraulic permeability. This hypothesis is supported by the rejection of sodium chloride and magnesium chloride displayed by the membranes made using the two different supporting electrolyte solutions. The rejection of these salts is greater when no supporting electrolyte was used during the printing of the thin films than when a 0.5 M NaCl solution was implemented. On the contrary, the film prepared with 0.5 M NaCl showed a larger rejection of sodium sulfate than that of the film prepared without any supporting electrolyte. These experimental results, which are in good qualitative agreement with reported results obtained from similar types of thin films made by dip-coating, demonstrate that inkjet printing combined with layer-by-layer (LbL) is a promising and advantageous route toward the fabrication of selective multilayer thin films.

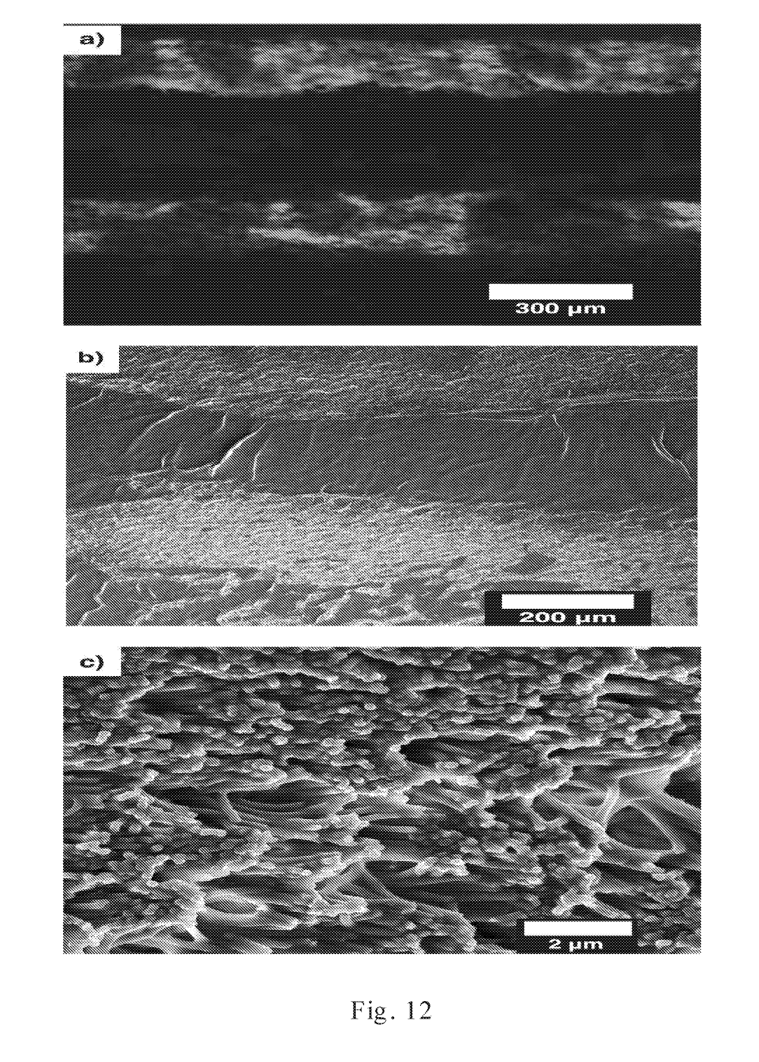

FIG. 12 displays fluorescent and SEM micrographs of PVA nanowires printed as patterned stripes. Alternating stripes of PVA and PEO were printed onto a PCTE membrane that had pores about 200 nm in diameter. After drying the membrane in an oven, it was transferred onto an APTES-treated glass slide and put in an oven at about 100° C. for about one hour. Subsequently, the PCTE membrane template and PEO stripes were dissolved in dichloromethane and the PVA nanowires were imaged. In (a) of FIG. 12, a fluorescent micrograph is shown of PVA nanowire stripes (about 200 μm width) and gaps (about 400 μm width). In (b) of FIG. 12, a SEM micrograph is shown of the PVA nanowire stripes (about 200 μm width) and the gaps (about 200 μm width) that result from dissolution of PEO. In (c) of FIG. 12, a higher magnification SEM micrograph is shown of the printed PVA nanowires.

There are several factors affecting processing time. In general, for the methods reported here, the processing time was dominated by the solution deposition time, which varied with a number of factors, including the number of print nozzles implemented, the size of the printed area, and the number of overprints applied. The more nozzles in the print head used to eject material, the more rapid the printing process. We conducted a rough scaling analysis to investigate the processing times. In our efforts, the number of nozzles was set to the maximum value (59 nozzles) for the Epson Workforce 30 to allow the shortest printing time. This highlights one route toward faster processing, parallelization. Using 59 nozzles in parallel with each depositing one overprint over a 1 cm length of substrate, it takes about 5 seconds to print 59 lines of one solution, which is about 0.83 cm in total height. Increasing the printing area and number of overprints, increases the processing time proportionally. For example, the PVA nanotubes were printed over about a 1 cm² area using five overprints and took about 40 seconds to fabricate. This can be broken down generally as follows. Five overprints over an area of about 0.83 cm² required about 25 sec and five overprints over the remaining about 0.17 cm² took another approximately 15 sec. A similar scaling was observed in the experiment to fabricate PAH/PSS nanotubes. It took about 17 minutes to print one PAH/PSS bilayer over about a 1 cm×1 cm area. This involved printing PAH and PSS each at twenty overprints with a rinsing step (depositing forty overprints of DI water) after each polyelectrolyte deposition step. This can be broken down generally as follows. 120 overprints over an area of about 0.83 cm² took about 600 sec (10 min) and 120 overprints over the remaining about 0.17 cm² required about 420 sec (7 min).

### Example 6A: Preparation of Polymer Composite Inks for Fabricating Charge Mosaics

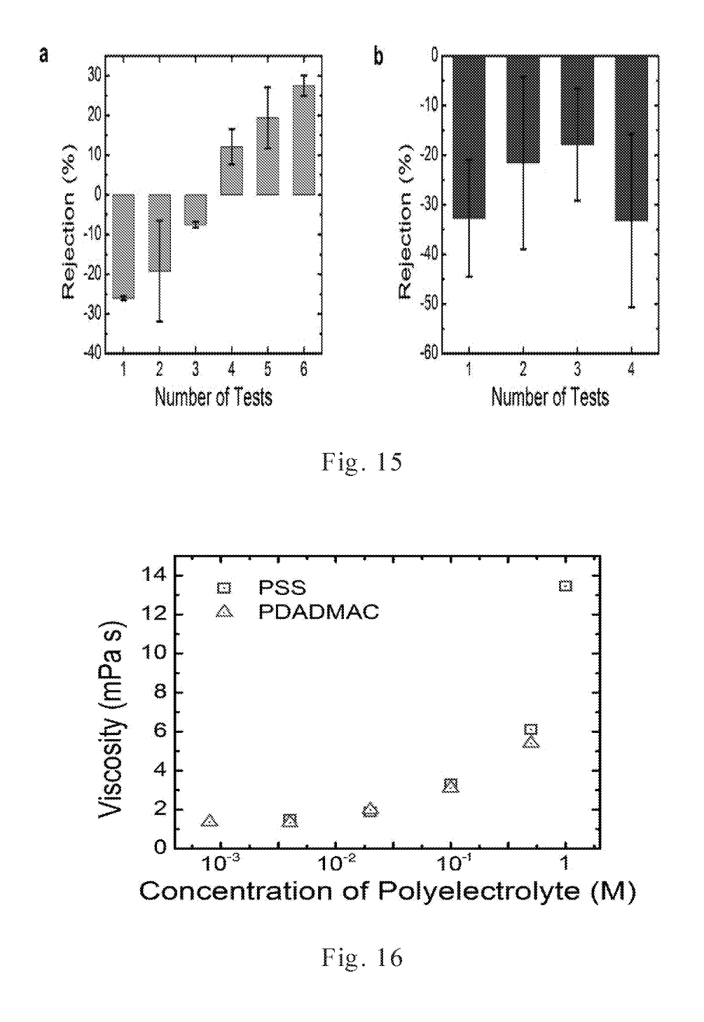

The generation of polymeric composite inks with varied functionality was advantageous to fabricating charge mosaic membranes using a combination of inkjet printing and template synthesis. The composite inks used in these experiments contained polyvinyl alcohol (PVA), a charged polyelectrolyte, and a fluorescent dye dissolved in deionized (DI) water. Each component in the formulation of the inks served a specific purpose. PVA is commonly used for preparing polymeric composites because it can be easily cross-linked to form a semi-interpenetrating network that entraps a functional component (FIG. 14 and FIG. 15).

FIG. 14 shows a Fourier transform infrared spectroscopy (FTIR) spectra and fluorescent images of printed membranes with or without chemical crosslinking. The figure demonstrates that crosslinking the poly(vinyl alcohol) (PVA) matrix material helps to stabilize the printed charge mosaic membrane. Stripes about 100 μm stripe wide were printed on a polycarbonate track-etched (PCTE) template using a polymer composite ink containing about 1 wt % (by weight) PVA, 0.5 M poly(styrene sulfonate) (PSS), and 5 μM 5 μM sulfo-Cyanine5 (Cy5). Crosslinking was carried out in the vapor above an aqueous solution containing about 25% (by weight) glutaraldehyde and an aqueous solution containing about 37% (by volume) hydrochloride acid at about 45° C. for about 24 hours. Subsequently, both the cross-linked and uncross-linked membranes were soaked in water for about one hour and dried in air. In (a) of FIG. 14, a FTIR spectra for two membranes is shown. The decrease in the transmittance of the broad hydroxyl peak at about 3650-3200 cm⁻¹ is consistent with the reduced concentration of hydroxyl groups in PVA. In (b) of FIG. 14, a fluorescent micrograph of the uncross-linked membrane is shown, which demonstrates the loss of fluorescent dye. In (c) of FIG. 14, a fluorescent micrograph of the cross-linked membrane is shown, which demonstrates the retention of the fluorescent dye.

FIG. 15 displays the stability of salt rejection measurements for charge mosaic membranes cross-linked under different conditions. The figure shows that the stability of salt rejection in the charge mosaic membrane can be improved by proper chemical cross-linking. The membranes were covered with about 52% (by area) positive domains. For salt rejection measurements, the membrane was mounted in a dead-end filtration cell filled with 0.1 mM potassium chloride (KCl) as a feed solution. A pressure of about 4 bar was applied. The salt rejection test was repeated by replacing the feed solution with a fresh 0.1 mM KCl solution. In (a) of FIG. 15, the membrane used in the salt rejection experiments was cross-linked in the vapor above an aqueous solution containing about 25% (by weight) glutaraldehyde at about 45° C. for about 24 hours. In (b) of FIG. 15, the membrane used in the salt rejection experiments was cross-linked in the vapor above an aqueous solution containing about 25% (by weight) glutaraldehyde and an aqueous solution containing about 37% (by volume) hydrochloride acid at about 45° C. for about 24 hours.

The reported method is versatile due to its ability to generate polymer composite inks with an almost arbitrary number of functionalities as long as suitable solvents and templates can be identified. In this patent, where we fabricated charge mosaic membranes successfully, polyelectrolytes were used as the functional component to impart charge to the membrane. In particular, the polyelectrolytes, poly(diallyldimethylammonium chloride) (PDADMAC) and poly(sodium 4-styrene sulfonate) (PSS) were used as the functional component of the positively-charged ink and negatively-charge ink, respectively, because they are strong polyelectrolytes that possess high charge densities over a wide pH range. The fluorescent dye was used to enable visual observation of the printed domains.

Two factors affected the formulation of the polymer composite inks. First, a solution with a dynamic viscosity less than about 20 mPa s was utilized to ensure smooth jetting of the inks onto the template surface. For this reason, about a 1% (by weight) solution of PVA in water served as the base of the polymer composite inks (FIG. 16). FIG. 16 shows the viscosity values of polymer composite inks containing different concentrations of polyelectrolytes. The figure shows that viscosity increases with the concentration of the polyelectrolytes. Positively charged inks contained poly(diallyldimethylammonium chloride) (PDADMAC). Negatively charged inks contained poly(styrene sulfonate) (PSS). Samples were loaded into a capillary tube in an Anton Paar Automated Micro Viscometer. Viscosity was measured at about T=22° C. An angle of about 30 degrees was used to measure the viscosity of most samples. Samples that appeared to be more viscous by visual inspection were run at angles of either about 50 or about 60 degrees to reduce the measurement time.

FIG. 17 shows streaming current of charge-functionalized membranes prepared using a combination of inkjet printing and template synthesis. The composition of the polymer composite ink and the printing conditions can be used to control the surface charge density and nanostructure of the charge-functionalized membranes. The charge-functionalized membranes were printed while applying a constant vacuum of about 12 psig to the substrate. A PCTE membrane with about 30 nm pores was used as the substrate in all experiments. In (a) of FIG. 17, streaming current is shown for membranes printed with varying concentrations of polyelectrolyte in the polymer composite ink. Three overprints were used. The polymer composite inks contained about 1% (by weight) poly(vinyl alcohol) (PVA) and a polyelectrolyte at the prescribed concentration dissolved in deionized (DI) water. Positively charged inks contained poly(diallyldimethylammonium chloride) (PDADMAC). Negatively charged inks contained poly(styrene sulfonate) (PSS). In (b) of FIG. 17, streaming current is shown for membranes printed with different values for the number of overprints. The polymer composite inks in these experiments were a solution of 1% (by weight) PVA and 0.1 M PDADMAC in deionized (DI) water and a solution of about 1% (by weight) PVA and about 0.5 M PSS in DI water for the positively-charged and negatively-charged inks, respectively. In (c) of FIG. 17, the mosaic membrane structure is shown after dissolving the PCTE substrate by immersing the charge mosaic in dichloromethane. A mesh of nanowires form inside the pores of the PCTE membrane. In (d) of FIG. 17, a higher magnification micrograph is shown of the nanowires formed within the pores of the PCTE substrate.

The second consideration that impacted the formulation of the precursor inks was the density of functional moieties within the final composite material. As displayed in (a) of FIG. 17, this variable can be adjusted by incorporating different concentrations of polyelectrolyte into the polymer composite ink. In (a) of FIG. 17, it is shown how the streaming current of the printed membranes changed as the concentrations of polyelectrolyte in the precursor ink was varied. In these experiments, polymer inks of a single type (i.e., PDADMAC-containing or PSS-containing) were printed onto a polycarbonate track-etched (PCTE) membrane with pores about 30 nm in diameter. Subsequently, the streaming current, which is proportional to the surface charge, was measured using a previously reported method. Using this method, surfaces with a positive charge generated a negative streaming current, while surfaces with a negative charge generated a positive streaming current. The magnitude of the streaming current for both of the membranes increased monotonically for polyelectrolyte concentrations that ranged from about 0.004 M to about 0.1 M, which indicated an increase in surface charge density. For the PSS-based membranes, the streaming current appears to asymptote above a polyelectrolyte concentration of about 0.1 M, suggesting a saturation concentration is reached. A concentration higher than about 0.1 M was not implemented for the PDADMAC-based membranes because at polyelectrolyte concentrations greater than about 0.1 M, the PDADMAC-containing inks were prone to clogging the print head. Inks that contained about 0.1 M PDADMAC and about 0.5 M PSS were used in all of the following experimentation due to their suitability for printing and because domains generated from these inks exhibited relatively large streaming currents that were nearly equal in magnitude, but opposite in sign, which is needed to produce high performance charge mosaic membranes.

We next reviewed the selection of materials deposition conditions. In addition to the intrinsic properties of the polymer composite ink upon formulation, the materials processing conditions affect the surface charge of the printed membrane. Controlling the number of ink droplets jetted at each location of the print head, defined as the number of overprints, is advantageous to tailoring the surface charge density of the membrane materials. In (b) of FIG. 17, it is shown how the surface charge of printed membranes varied with the number of overprints when charged inks were printed onto a PCTE template. The PCTE template (zero overprints) generated a positive streaming current due to the negative charge on its surface. The sign of the streaming current for the membrane printed with PDADMAC-containing ink flipped and its magnitude gradually decreased to a more negative value with an increasing number of overprints, which indicated that the surface charge of the membrane became more positive as larger volumes of ink were deposited onto the membrane. The result fits well with the hypothesis that as ink is pulled through the open pores of the PCTE template, the polymeric components are deposited on the pore wall of the template, covering and eventually screening the initially-negatively charged surface. Scanning electron microscopy (SEM) micrographs of the membrane after the PCTE template had been dissolved further support this hypothesis.

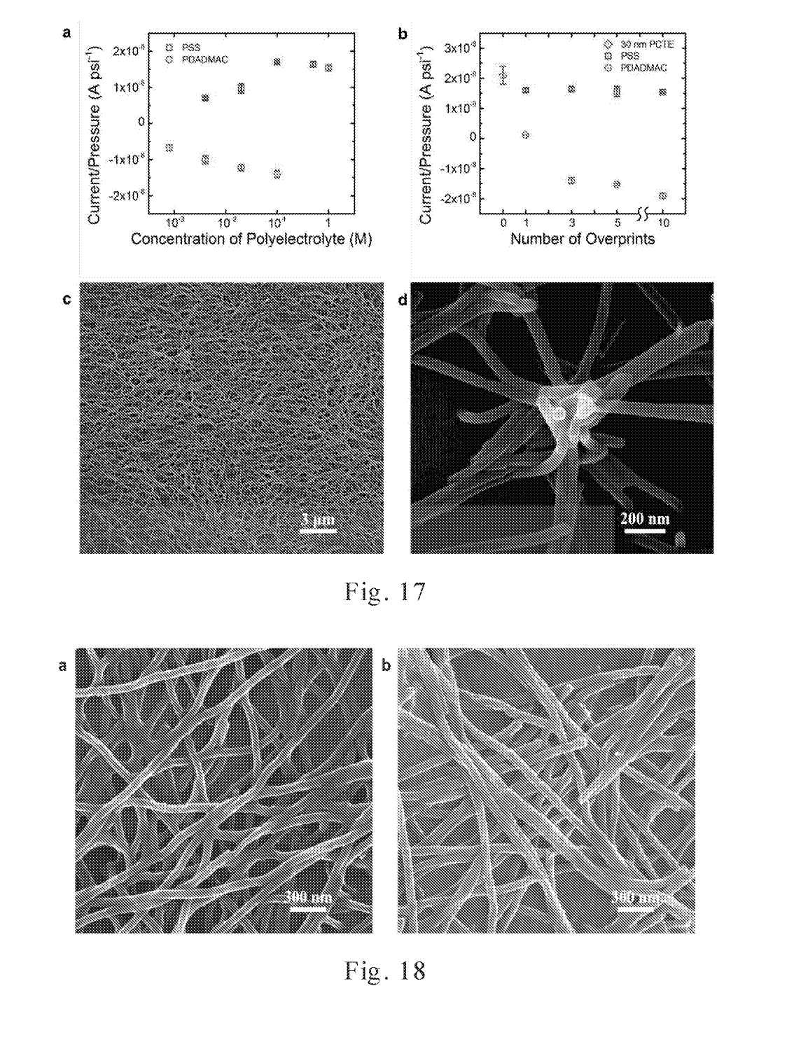

In (c) of FIG. 17, a lower magnification image is displayed, which shows a mesh of nanowires after the dissolution of the template. The higher magnification micrograph in (d) of FIG. 17 shows that the diameter of the nanowires in the mesh is around 42±3 nm, which is consistent with the about 30 nm pore size reported for the PCTE template. This result is in good agreement with the experiments described above combining inkjet printing with template synthesis. See also Gao, P.; Hunter, A.; Benavides, S.; Summe, M. J.; Gao, F.; Phillip, W. A.; Template Synthesis of Nanostructured Polymeric Membranes by Inkjet Printing, ACS Appl. Mater. Interfaces (2016), 8, pages 3386-3395. A side-by-side comparison of SEM micrographs of the nanowires formed using PSS-containing and PDADMAC-containing inks demonstrates that the nanowires formed in the negative and positive domains possess similar nanostructures (FIG. 18).

The surface charge of the membrane printed with the PSS-containing ink showed little change as the number of overprints was varied, which suggests that the negative ink covered the pore surface with a similar density of charged moieties as that present on the surface of the PCTE template. Based on the results above, five overprints were chosen for all subsequent experimentation because the positive and negative inks produced similar values of surface charge.

FIG. 18 shows SEM images of the PVA/PDADMAC and PVA/PSS nanowires after dissolving the PCTE template membrane. To prepare the sample in (a) of FIG. 18, a solution of about 1% (by weight) PVA and about 0.1 M PDADMAC was printed on a about 30 nm PCTE membrane with five overprints and the PCTE template was removed by dissolving it in dichloromethane. The sample in (b) of FIG. 18 was prepared with the same procedure with a solution of about 1% (by weight) PVA and about 0.5 M PSS. No significant differences can be seen between PDADMAC-based and PSS-based nanostructures. A small number of voids were present on the PSS-based nanowires, which may result from a phase separation process during membrane preparation. When printed with equal areal fractions, these two inks produced a charge mosaic membrane that satisfied the design constraint of an overall neutral membrane surface.

We tested the printing of charge mosaic membranes. Using inkjet printing allowed for the patterning of the charged domains on the membrane surface to be controlled in a straightforward manner, which, thereby, enabled the formation of charge mosaic membranes. We demonstrated the use of this facile and scalable method for producing a charge mosaic membrane that is capable of enriching (i.e., increasing) the salt concentration in the permeate relative to the feed. A pattern of alternating stripes was used because it allowed the areal fraction of positively-charged domains to be adjusted by modifying the relative width of the stripes.

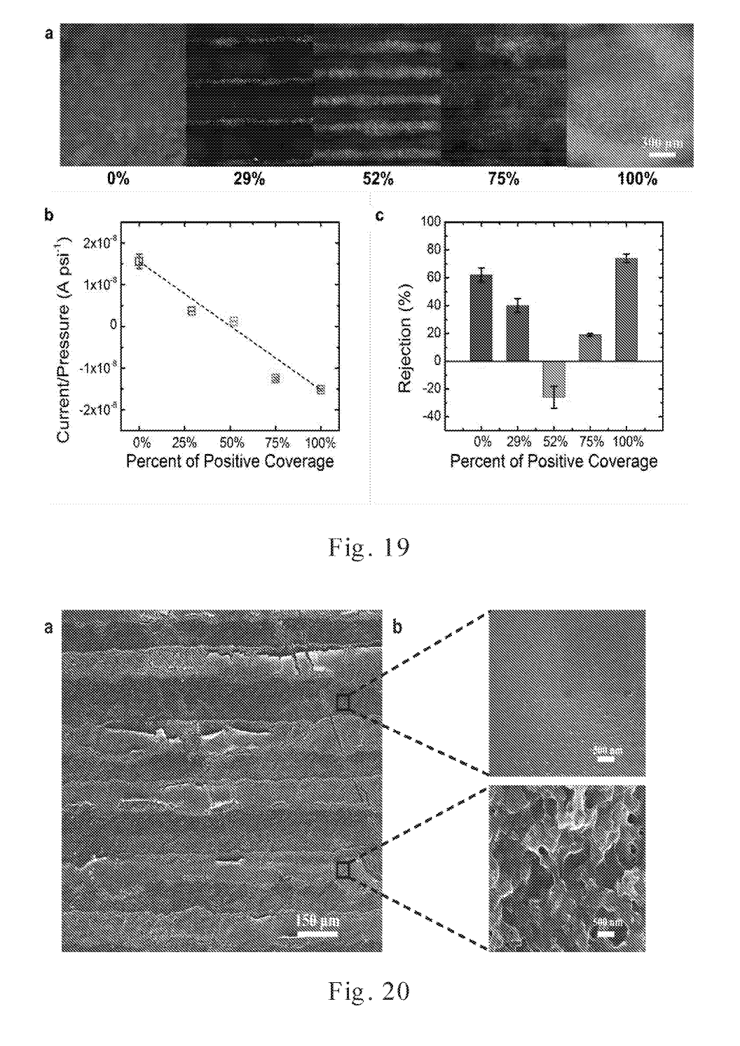

FIG. 19 shows fluorescent images, streaming current, and salt rejection for charge mosaic membranes printed with different areal fractions of positive and negative charge. The patterning of membranes fabricated using a combination of inkjet printing and template synthesis can be easily adjusted in order to control the surface charge and transport properties of the charge mosaic membrane. A PCTE membrane with a pore diameter of about 30 nm was used as a substrate in all experiments. Positive regions were formed by printing a polymer composite ink that contained about 1% (by weight) PVA, 0.1 M PDADMAC, and about 5 μM FITC-PAH. Negative regions were formed by printing a polymer composite ink that contained about 1% (by weight) PVA, about 0.5 M PSS, and about 5 μM CyS. In (a) of FIG. 19, shown in the fluorescent micrographs, the positive regions appear green in color (e.g., the far right (100%) panel) and the negative regions appear purple in color (e.g., the far left (0%) panel). The fraction of the membrane surface covered by the oppositely-charged moieties was controlled by printing stripes of different widths. In (b) of FIG. 19, the streaming current of the charge mosaic membranes was measured using a 10 mM potassium chloride (KCl) solution with unadjusted pH. Pressure was applied to the side of the system connected to the positive terminal of the source meter. Error bars represent the standard deviation (n=3). In (c) of FIG. 19, salt rejection of a 0.1 mM KCl feed solution is shown. Experiments were executed with the charge mosaic membranes mounted in a dead-end filtration cell. An applied pressure of about 4 bar was used to drive permeation. Error bars represent multiple tests (n=4) on a single membrane.

In (a) of FIG. 19, fluorescent micrographs are shown of membranes with areal fractions of the positively-charged domain that range from 0% to 100%. In these micrographs, the negatively-charged domains appear purple and the positively-charge domains appear green. Printing only the PSS-containing and the PDADMAC-containing inks on the membranes surface generated about 0% and about 100% surface coverage, respectively. An intermediate areal fraction corresponding to about 29% coverage was generated by printing stripes with widths of 106±7 μm (PDADMAC-containing) and 257±7 μm (PSS-containing). About 52% coverage was generated from stripes with widths of 94±5 μm (PDADMAC-containing) and 101±7 (PSS-containing). About 75% coverage was produced using stripes with widths of 294±10 (PDADMAC-containing) and 96±9 μm (PSS-containing).

We examined the transport characteristics of charge mosaic membranes. The hydraulic permeability of the printed mosaic membranes ranged from about 0.6 to about 3.0 L m⁻² h⁻¹ bar⁻¹ and are listed as a function of the areal coverage of positive domains in Table 1.

TABLE 1
Hydraulic permeability of charge mosaic membranes printed with
different areal fractions of positive and negative charge.

| Percent of | Hydraulic permeability |
|---|---|
| positive coverage | (L m⁻² h⁻¹ bar⁻¹) |
| 0% | 2.3 ± 0.5 |
| 29% | 1.7 ± 0.4 |
| 52% | 1.0 ± 0.3 |
| 75% | 2.1 ± 0.6 |
| 100% | 2.8 ± 0.5 |

The streaming currents measured for this series of membranes are displayed in (b) of FIG. 19. Membranes printed with only the PSS-containing ink displayed the most positive streaming current, which corresponds to the highest density of negatively charged moieties. The streaming current decreased monotonically as the surface coverage of the positive domain increased. Given the streaming current of the positively-charged and negatively-charged membranes, the streaming current for the mosaic membranes can be predicted using a weighted arithmetic average of the streaming currents of the positive and negative domains as shown by the dashed line in (b) of FIG. 19. The fractional coverage of the membrane surface area is used as the weighting factor. These values are calculated using Equations (2) and (3):

$$\begin{matrix}{( \frac{I}{Δ P} )}_{mosaic} = {{ɛ}_{+} ( \frac{I}{Δ P} )}_{+} + {{ɛ}_{-} ( \frac{I}{Δ P} )}_{-} & ( 2 ) \\ {( \frac{I}{Δ P} )}_{mosaic} = {( \frac{I}{Δ P} )}_{-} + {ɛ}_{+} [ {( \frac{I}{Δ P} )}_{+} - {( \frac{I}{Δ P} )}_{-} ] \\ where {( \frac{I}{Δ P} )}_{-} , {( \frac{I}{Δ P} )}_{+} , and {( \frac{I}{Δ P} )}_{mosaic} & ( 3 )\end{matrix}$$

are the streaming current of the negative domains, positive domains, and mosaic membranes, respectively, and ε− and ε+, are the fractional coverage of the mosaic membrane surface area for the negative and positive domains, respectively.

This suggests that, as designed, discrete domains of positive charge and negative charge are produced upon printing, and that the methods reported herein enable control of the relative surface coverage of multiple domains. Examining the morphology of the charge mosaic using SEM also confirms that discrete domains are formed. FIG. 20 shows SEM micrographs of a charge mosaic membrane. The micrographs depict the distinct nanostructures of the oppositely-charged domains on the surface of the charge mosaic membrane. The mosaic membrane was patterned by printing alternating stripes, about 100 μm in width, of positively-charged inks (about 1% (by weight) PVA/0.1 M PDADMAC/5 μM FITC-PAH in water) and negatively-charged inks (about 1 wt % PVA/0.5 M PSS/5 μM Cy5 in water) onto a PCTE membrane with pores about 30 nm in diameter. Five overprints were used and a constant vacuum of about 12 psig was applied to the substrate. In (a) of FIG. 20, the top surface of the charge mosaic membrane is shown. In (b) of FIG. 20, higher magnification micrographs are shown of the positively-charged (top) and negatively-charged (bottom) regions of the mosaic membrane. In (a) of FIG. 20, the pattern of alternating stripes is shown printed with about 52% areal coverage for the positive domain. From this micrograph, it is clear that the topology of the two domains appear different. Higher magnification micrographs ((b) of FIG. 20) demonstrate that the positively-charged domains are smooth, while the negatively-charged domains are rough. This surface roughness is characteristic of composites that contain PVA and PSS. The differences in the appearances of the stripes and the variations in the streaming current further confirm that discrete domains are generated by the combination of inkjet printing and template synthesis.

The salt rejecting capabilities of membranes that possess only a single type of charge are fairly well established for simple salts, such as sodium chloride (NaCl) and potassium chloride (KCl). However, the effects of surface charge on the performance of mosaic membranes are not as well established. Therefore, salt rejection experiments for membranes patterned with different areal fractions of positively-charged domains were executed using a 0.1 mM potassium chloride (KCl) feed solution ((c) of FIG. 19). The low feed solution concentration was selected to ensure that ion selectivity for the individual domains remained high. Membranes printed with only the PSS-containing (about 0%) or PDADMAC-containing (about 100%) inks showed the highest salt rejection, which was expected based on the high surface charge measured for these membranes ((b) of FIG. 19). As mosaic patterning was incorporated into the membranes (about 29% and about 75% coverage), the salt rejection values remained positive, but their magnitude was reduced from about 65% to about 25% rejection. The lower rejection of dissolved salts is in good agreement with the decreased overall surface charge of the membranes. An interesting result comes from the membrane printed with equal areal coverage of the positive and negative domains (about 52%). This membrane, which had a nearly neutral surface charge, produced a negative salt rejection (i.e., it enriched the concentration of salt in the permeate relative to the feed). For single salt systems, this is a characteristic unique to charge mosaic membranes.

Because electrostatic interactions between the membrane and dissolved ions play a significant role in the performance of charge-functionalized membranes, KCl enrichment was measured for feed solution concentrations of 1 mM and 10 mM to study the impact of ionic strength of the performance of charge mosaic membranes. A rejection of −17±5% for the 1 mM feed solution and −2.0±1.6% for the 10 mM feed solution were observed, indicating that the mosaic membrane was able to enrich the salt concentration even for these more concentrated feed solutions. Further inspection of these results indicated that membrane performance was optimal when the Debye length is greater than the pore radius, which is consistent with previous reported studies on other charge-functionalized membranes. The Debye length for a surface in a 0.1 mM and 1 mM KCl feed solution (30.5 nm and 9.6 nm, respectively) is greater than the radius of the pore of the printed membranes estimated from PEO rejection experiments, 6.3 nm. However, the Debye length for the 10 mM feed solution, 3.1 nm, is smaller than the estimated pore size.

The pore diameter (dₚ) of the printed membrane (pore size estimated from rejection of PEO) can be estimated based on the percent rejection (R) of PEO molecules with a known solute size (dₛ) using equation (4).

R=1−[(1−λ)²[2−(1−λ)²]exp(−0.71462²)] (4)

where λ=dₛ/dₚ. This method gives dₚ value of 12.6 nm with 49% rejection of 10 kDa PEO (5.7 nm). This result indicates that developing charge mosaics from templates with smaller pores can be a straightforward route toward the generation of charge mosaic membranes that perform well in high ionic strength environments.

The general procedure to print and characterize the charge mosaic membranes involves the following steps: 1. The polymer composite inks are prepared by dissolving polyvinyl alcohol, a charged polyelectrolyte, and a fluorescent dye in DI water; 2. Charge mosaic membranes were prepared by printing predesigned patterns of the polymer composite inks onto a template substrate and then chemically crosslinking the composite; and 3. Charge mosaic membranes were characterized using a series of techniques including streaming current measurements, fluorescent microscopy, scanning electron microscopy, and transport tests.

### Example 6B: More Preparation of Polymer Composite Inks for Fabricating Charge Mosaics

The polymer composite inks contained PVA, a charged polyelectrolyte, and a fluorescent dye dissolved in DI water. The viscosity of the ink is a significant consideration when formulating the polymer composite ink. Specifically, the dynamic viscosity should be less than about 25 mPa s or less than about 20 mPa s to avoid clogging of the printer head. It is known that the concentration of PVA dissolved in DI water affects the solution viscosity. Therefore, about a 1% (by weight) solution of PVA in water, which has a viscosity of 1.35 mPa s, was chosen for all experiments to ensure a smooth ink jetting. The about 1% (by weight) PVA solution was prepared by dissolving PVA powder in water at about 80° C. for about 24 hours. It was then filtered through an Acrodisc 25 mm syringe filter fitted with a 1 μm glass fiber membrane. The filtration removes any suspended PVA particles that would clog the printer head.

The polyelectrolyte PDADMAC was added to the PVA solution to render a positively-charged composite ink. The negatively-charged ink was prepared by adding PSS to the 1% (by weight) PVA solution. The concentration of polyelectrolyte incorporated into a polymeric composite was previously reported to affect the overall charge of the material. As such, a series of polymer composite inks with varying polyelectrolyte concentrations were prepared. For clog-free considerations, the concentrations of PDADMAC and PSS incorporated in the composite inks used to fabricate charge mosaics were 0.1 M (3.1 mPa s) and 0.5 M (6.12 mPa s), respectively.

Fluorescent dyes were added to the composite inks for direct observation of the printed domains using fluorescent microscopy ((a) of FIG. 19). 5 μM of FITC-PAH was mixed into the positively charged PVA/PDADMAC ink. This dye appears green in color in the fluorescent micrographs. 5 μM of Cy5 was added to the negatively charged PVA/PSS ink. This dye appears purple in color in the fluorescent micrographs. The concentrations of the dyes are adequate for imaging purposes, but low enough not to affect the overall charge of the composite materials (Table 2). The compositions of the polymer composite inks used for printing charge mosaic membranes were about 1% (by weight) PVA/0.1 M PDADAMC/5 μM FITC-PAH and about 1% (by weight) PVA/0.5 M PSS/5 μM Cy5.

TABLE 2
Streaming current measurements for membranes printed using polymer
composite inks with and without the addition of fluorescent dyes.

| Polyelectrolyte | | |
|---|---|---|
| in | Streaming Current (A psi⁻¹) | Streaming Current (A psi⁻¹) |
| composite ink | w/ fluorescent dye | w/o fluorescent dye |
| PDADMAC | −1.52 × 10⁻⁸ ± 3.1 × 10⁻⁹ | −1.55 × 10⁻⁸ ± 2.4 × 10⁻⁹ |
| PSS | 1.56 × 10⁻⁸ ± 1.7 × 10⁻⁹ | 1.50 × 10⁻⁸ ± 1.7 × 10⁻⁹ |

The polymer composite inks in these experiments were a solution of about 1% (by weight) PVA and about 0.1 M PDADMAC in DI water and a solution of about 1% (by weight) PVA and about 0.5 M PSS in DI water for the positively-charged and negatively-charged ink, respectively. Membranes printed with fluorescent dyes included 5 μM fluorescein isothiocyanate-labeled poly(allylamine hydrochloride) (FITC-PAH) in the positively-charged ink and 5 μM sulfo-Cyanine5 (Cy5) added to the negatively-charged ink. Five overprints were used. The streaming current of the membranes was measured using a 10 mM potassium KCl solution with unadjusted pH.

### Example 7: Printing Procedure

Predesigned patterns were written in scripts and printed using a Jetlab® 4 xl-A system (MicroFab Technologies), which uses piezoelectric actuation technology to eject the ink droplets. Two fluid channels with 50-μm-diameter orifice were used to inkjet the polymer composite inks. The number of droplets ejected at the same location (defined as number of overprints) was controlled through the preprogrammed scripts. Due to their well-defined pore structure and prior experience with these membranes, PCTE membranes (pore diameter: about 30 nm; membrane thickness: about 10 μm; porosity: about 3×10⁸ pores cm⁻²) were used as structural templates. Prior to printing, the PCTE was fixed onto an in-house vacuum device and a constant vacuum of about 12 psig was applied to the PCTE membrane during printing for all experiments. The vacuum device is described above and in the Gao et al paper, supra.

Membranes functionalized with a single charge type (i.e., negative or positive charge) were fabricated by printing a charged polymeric composite ink of a single type onto the PCTE template. Charge mosaic membranes were formed by printing alternating stripes of positively-charged and negatively-charged inks. The width of the positively-charged and negatively-charged stripes were varied independently to control the areal fraction of the positively-charged regions on the membrane surface. The minimum value of for the stripe width was about 100 μm. Charge mosaic membranes with about 29%, about 52%, and about 75% of positively-charged regions were printed from written scripts with 100 μm PDADMAC/300 μm PSS, 100 μm PDADMAC/100 μm PSS and 300 μm PDADMAC/100 μm PSS, respectively.

### Example 8: Characterizing Surface Charge of the Charge Functionalized Membranes

Streaming current measurements were used to determine the sign and magnitude of the charge imparted to the PCTE template by the polymer composite inks. It was also used to determine the overall average surface charge of the charge mosaic membranes. The procedure for measuring the streaming current is described above and in the Gao et al paper, supra. A membrane square (1.5 cm×1.5 cm) was prepared to fit in a custom built U-tube cell device that measures streaming current. A more detailed description of the device is described above and in the Gao et al paper, supra. Three overprints of either the positively-charged or negatively-charged ink was printed on the PCTE membranes and the effects of polyelectrolyte concentration on surface charge was investigated.

The results of the streaming current measurements can be used to calculate the surface charge density of the membranes as demonstrated by Equations 5-8. Using Equation (5) and the ratio of the streaming current (I) to pressure (ΔP) obtained from experiments, the zeta potential (ζ) of the membrane surface in contact with solution can be estimated.

$$I = \frac{ɛζΔ P}{η l} {A}_{p} \qquad ( 5 )$$

where ε is the permittivity of water (6.93×10⁻¹⁰ coulomb volt⁻¹ meter⁻¹), η is the viscosity of the solution (1 mPa s), 1 is the thickness of the membrane (10 μm), and Aₚ is the area of the pore. Aₚ can be estimated by Equation (6) using the areal density of pores (ρ, 3×10⁸ pores cm⁻²), the pore radius (r), and the exposed area of the membrane (Aₘ, 0.126 cm²).

Aₚ=Aₘρπr² (6)

By combining Equation (5) and (6), ζ is related to (I/ΔP): Equation (7).

$$ζ = \frac{I}{Δ P} \frac{η l}{ɛ {A}_{e} ρπ {r}^{2}} \qquad ( 7 )$$

Subsequently, the surface charge density (σ) of the membrane can be determined using Equation (8).

$$σ = \frac{ζɛ}{{κ}^{- 1}} \qquad ( 8 )$$

where κ⁻¹ is the Debye length (κ⁻¹=3.1 nm for 10 mM potassium chloride) at the membrane surface/electrolyte solution interface.

TABLE 3
Zeta potential and surface charge density estimated as a function of pore
radius. A representative value of I//ΔP = 2 × 10⁻⁸ A psi⁻¹ was assumed.

| Pore radius r (nm) | ζ (mV) | σ (μcoulomb cm⁻²) |
|---|---|---|
| 2 | −353.6 | −8.17 |
| 10 | −14.1 | −0.33 |
| 20 | −3.5 | −0.08 |
| 30 | −1.6 | −0.04 |

These calculations, however, rely on several assumptions regarding the nanostructure of the membrane and the magnitude of the surface charge, which is why we reported the experimentally measured streaming current values.

### Example 9: Fluorescent and Electron Micrographs of the Charge Mosaic Membranes

The printed mosaic membranes were visualized using a fluorescent microscope (EVOS FL Auto, Thermo Fisher Scientific) equipped with the GFP and Cy5 light cubes. The morphology of the charge mosaic membranes at the nanoscale was characterized using a field emission scanning electron microscope (SEM) (Magellan 400, FEI) (described above and in the Gao et al paper, supra). 2.5 nm of Iridium was sputtered on the membrane by a sputter coater (208 HR, Cressington) to prevent sample charging during imaging.

### Example 10: Chemical Crosslinking of the Charge Mosaic Membranes

A glass chamber containing a beaker of about 37% (by volume) hydrochloric acid in water and a beaker of about 25% (by weight) glutaraldehyde in water was used as the reactor for vapor-phase crosslinking of the PVA matrix. The glass chamber was covered with a glass plate and the printed membranes were taped onto the top surface of the glass lid. The crosslinking reaction was conducted at about 45° C. for about 24 hours. Subsequently, the membranes were removed from the glass lid, rinsed in DI water for about 1 h, and dried in air.

### Example 11: Fourier Transform Infrared Spectroscopy (FTIR)

FTIR spectra were acquired using a FT/IR-6300 spectrophotometer (Jasco). Membranes of printed PVA mixtures were prepared with and without chemically cross-linking the PVA that was described above. FTIR was collected on these membrane samples in the range 4000-695 cm⁻¹ with resolution of every 1 cm⁻¹ and the average of 56 scans was used.

### Example 12: Transport Tests

The detailed procedure for measuring the hydraulic permeability and ion rejection of charge-functionalized membranes was described above and in the Gao et al paper, supra. Briefly, membranes were put in a stirred cell (model 8003, Amicon), which was filled with water. A pressure of about 4 bar was applied to drive permeation through the membrane. After about 2 h, the throughput stabilized, and the solution that permeated through the membrane was collected in a vial that rests on a balance. The mass of the permeate was recorded using LabVIEW software (National Instruments). This data was used to determine the hydraulic permeability of the membrane.

In ion rejection measurements, a 0.1 mM solution of potassium chloride was used as the feed solution. A pressure of about 4 bar was applied to drive the solution to permeate through the membrane, and the permeate solution was collected in a vial. During filtration experiments, the stirred cell was placed on a stir plate set at about 300 rpm to keep the feed solution well-mixed and minimize the influence of concentration polarization. Subsequently, ion chromatography (ICS-5000, Dionex) was used to analyze the concentration of potassium ions in the feed (c_{f}) and permeate solutions (cₚ). These measured values were used to calculate the percent rejection, R, according to Equation 8:

$$R ( \% ) = ( 1 - \frac{{c}_{P}}{{c}_{F}} ) \times 100 \qquad ( 8 )$$

where cₚ and c_{f} is the concentration of ion measured in the permeate and the feed, respectively.

In poly(ethylene oxide) (PEO) rejection experiments, a similar procedure as the ion rejection measurements was used. The results of these experiments can be used to estimate the pore size of the printed membrane. A solution with 10 kg mol⁻¹ PEO dissolved in 1 g L⁻¹ was used as the feed solution. The concentration of PEO in the permeate solution was measured with a Shimadzu TOC-TN Organic Carbon Analyzer. The percent rejection was calculated by Equation 8.

### CONCLUSIONS

We have shown the fabrication of polymeric nanomaterials through the combination of inkjet printing and template synthesis. We demonstrated the successful fabrication of nanostructured materials using polymeric nanowires, polyelectrolyte nanotubes, and layer-by-layer thin films as examples. Through these examples, it was demonstrated that, when tested in membrane applications, the nanostructure and functionality of the materials made using a combination of inkjet printing and template synthesis are comparable, and sometimes better, to those of their dip-coated counterparts. This data highlights the advantages of using inkjet printing for the fabrication of nanostructured polymeric materials, which include greatly reduced labor, materials requirements, and processing times, and the ability to form chemically patterned functional surfaces. As such, the methods described in this patent offer a promising way to fabricate, pattern, and modify nanomaterials with complex structures and functionalities.

We also demonstrated the fabrication of charge mosaic membranes through the combination of inkjet printing and template synthesis. The results of the experiments demonstrate conclusively that by changing the width of the stripes of charged inks deposited on the template surface, the surface charge and transport properties of charge mosaic membranes fabricated using a combination of inkjet printing and template synthesis can be easily adjusted. This unique ability can enable further studies on charge mosaic membranes that can be deployed in the established and emerging technologies where the selective transport of ionic solutes is important. Furthermore, the membrane fabrication platform demonstrated here, which relies on easily-tailored composite inks, can be extended to a wide range of matrix materials and functional components, and as such can enable the design and development of novel mosaic membranes with novel patterned surface chemistries and structures.

1. A method of preparing a polymeric nanomaterial comprising ink-jet printing a polymeric ink on a porous or non-porous sacrificial template and synthesizing the polymeric nanomaterial on the template.

2. The method of claim 1 where the polymeric nanomaterial is a nanotube or a nanowire and the steps comprise:
(i) ink-jet printing sequentially at least two layers of the polymeric ink on the porous sacrificial template while pulling a vacuum on the downstream side of the template; and
(ii) dissolving the sacrificial template in an organic solvent to form the polymeric nanotube or nanowire;

3. The method of claim 2 where the polymeric ink comprises a polyelectrolyte, a neutral polymer, or a combination thereof.

4. The method of claim 3 where the polyelectrolyte comprises a polyanion, polybase, or combination thereof.

5. The method of claim 3 where the neutral polymer comprises a polysaccharide, a cellulose derivative, a synthetic polymer, or a combination thereof.

6. The method of claim 3 where the template comprises a track-etch membrane, a self-assembled membrane, a phase inversion membrane, an inorganic membrane or a ceramic membrane.

7. The method of claim 3 where the organic solvent comprises an ester, a ketone, an alcohol, an ether, an acid or a base.

8. The method of claim 3 where at least two different types of polymeric ink are ink-jet printed alternatively on the template.

9. The method of claim 8 where the two different types of polymeric ink have opposite charges to form alternative positive and negative charged layers.

10. The method of claim 3 where the viscosity of the polymeric ink is less than or equal to about 25 mPa.

11. The method of claim 3 where the concentration of the polyelectrolyte is between about 0.01 mM and about 1.0M.

12. The method of claim 3 where the concentration of the neutral polymer is between about 0.1 wt % and about 2 wt %.

13. The method of claim 3 where the polymeric ink comprises water.

14. A method of preparing a polymeric film comprising ink-jet printing a polymeric ink on a porous or non-porous sacrificial template and synthesizing the polymeric film on the template.

15. The method of claim 14 where the polymeric film is a multi-layered film and the steps comprise ink-jet printing sequentially at least two layers of the polymeric ink on the porous or non-porous template in the absence of an applied vacuum on the template to form the polymeric film.

16. The method of claim 14 where the film is a nanomaterial.

17. A method of preparing a functional mosaic membrane comprising ink-jet printing a polymeric ink on a porous or non-porous sacrificial template and synthesizing the functional mosaic membrane on the template.

18. The method of claim 17 where the functional mosaic membrane comprises a charge mosaic membrane comprising alternative layers of at least two different polymeric inks comprising polyelectrolytes of different charges to pattern positively-charged or negatively-charged domains, respectively, on the surface of the template.

19. The method of claim 17 where the polymeric ink comprises a polyelectrolyte comprising poly(diallyldimethylammonium chloride) (PDADMAC), poly(sodium 4-styrenesulfonate) (PSS), or a combination thereof.

20. The method of claim 17 where the polymeric ink comprises poly(vinyl alcohol) (PVA).
